(19) United States
(12) Patent Application Publication
(10) Pub. No.: US 2003/0023463 A1
(43) Pub. Date: Jan. 30, 2003

(54) Method and system for automatically planning, booking, and calendaring travel arrangements

(76) Inventors: Frank Dombroski, Scottsdale, AZ (US); Len Miller, Cave Creek, AZ (US); Francis Jacobs, Glendale, AZ (US)

Correspondence Address: FENNEMORE CRAIG, 3003 NORTH CENTRAL AVENUE, SUITE 2600, PHOENIX, AZ, 85012, US

(21) Appl. No.: 09/836,141

(22) Filed: Apr. 16, 2001

(51) Int. Cl. G06F 17/60

(52) U.S. Cl. 705/5

(57) ABSTRACT

A system for automatically planning, booking and calendaring travel arrangements includes a data storage device, a booking engine, an output device and a processor. Maintained in the storage device is a database of user profile information. The processor receives a travel request input including travel request data gathered from a user's calendar application. The stored user profile information and the travel request data is used to automatically formulate a travel request in response to the travel request input. The travel request includes airline, hotel and rental car reservation information. A travel query file is automatically created from the travel request. The creation of the travel query file includes: automatically executing an air booking process, based on at least two categories of user preference information selected from the categories of lowest price, arrival/departure time, airline, non-stop, duration, alternate airports and full fare automobile upgrades; automatically executing a car booking process; and automatically executing a hotel booking process. The travel query file is submitted to the booking engine for creating a travel request query. The travel request query is submitted to a travel distribution system for retrieving air, car and hotel availability information. Retrieved air, car and hotel availability information is used to create a suggested travel itinerary, which is outputted for display. The suggested travel itinerary can be manually changed or confirmed. The confirmed travel itinerary can be processed to automatically create and store appointment events in a user's calendar application.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates generally to the field of travel reservation and planning. More particularly, it relates to a method and system for initiating the automatic creation of a travel request from within a calendar application, the automatic generation of a suggested itinerary based on a traveler's personal profile, calendar data and schedule, and the booking and calendaring of the itinerary upon user review and approval.

A manual interactive travel booking process currently exists whereby the user enters a scheduled event into his computer calendar or schedule application and then must telephone a travel agent or, as is becoming a more common practice, log on, using the Internet and the World Wide Web (the “Web”), to one of the travel industry's websites, such as Expedia, Travelocity, or BizTravel.com, to book his travel arrangements. Each of these websites has unique characteristics. In general, however, they all require that the user register and sign-in, enter the departure city from which the travel commences, the destination city to which the travel is desired, and the desired travel dates and departure times for each leg of the trip. The site then returns a series of available airline flights, one of which the user must select for each leg of the journey. The user must complete a traveler profile, provide the appropriate payment information, and “book” the flight or flights. If the user wishes to make hotel reservations for the trip, he must navigate to a different section of the website, and indicate his desire to book hotel reservations. The user is again requested to provide the city and dates for which the hotel reservations are required, and is subsequently given a choice of several hotels and associated prices. The user must then select a specific hotel, and request more information about rates and availability at that hotel. Once again, the user must provide the required personal and payment information for the hotel of his choice and “book” the hotel room. If the user wishes to book a rental car as a part of his travel plans, he must, once again, proceed through a series of events similar to those required to book his hotel room.

Once the travel plans have been booked, the traveler often will want to schedule them onto his calendar to store them for reference or to check to see if any scheduling conflicts have inadvertently been generated. To do so, the user must manually enter the schedules for flight times, car pick-up and drop-off, and the like, into the user's calendar application. Some examples of such calendar applications include the Outlook application marketed by Microsoft Corporation of Redmond, Wash., the Lotus Notes application marketed by Lotus Development Corporation of Cambridge, Mass. or the eCal application marketed by Corporation of Philadelphia, Pa.

This current process of booking travel and calendaring the itinerary is slow, inefficient, complex, and prone to error. It requires that the user log onto an Internet website and, quite often, to enter information multiple times in order to book acceptable travel reservations. This current process frequently takes between twenty and thirty minutes for the traveler to book air, hotel and car reservations. For those companies that require employee travel as a part of their business profile, this represents a considerable commitment of time and resources to plan and coordinate travel arrangements.

In view of the above discussion, there exists a need in the art for a method and system to plan and calendar travel arrangements with minimal user intervention. Accordingly, it is an object of this invention to provide such a method and system.

Another object of the invention is to provide a method and system in which travel arrangements can be initiated from the user's calendar application.

Another object of the invention is to provide such a method and system that provides itinerary scheduling parameters from the user's calendar application.

Another object of the invention is to provide such a method and system that produces a suggested itinerary by incorporating industry standard booking engine technology that queries a Global Distribution System (GDS), the industry's electronic travel distribution system.

It is yet another object of the invention to provide such a method and system that produces a suggested itinerary by utilizing intelligence based upon pre-defined traveler preferences and profile information.

Another object of the invention is to provide such a method and system that automatically produces the suggested itinerary.

It is yet another object of the invention to provide such a method and system that adds the reviewed and approved itinerary to the user's calendar.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a method and system for automatically planning, booking and calendaring travel arrangements. A system in accordance with the invention includes a host computer system, a user's computer and a commercially available GDS. The host computer system includes a data storage device, a booking engine, an output device, and a processor. The processor is programmed to maintain in the storage device a database of user profile information including information regarding air travel booking preferences, car booking preferences, hotel booking preferences and personal preference air travel ratings. The processor also is programmed to receive a travel request input including travel request data gathered from a user's calendar application and to use the stored user profile information and the travel request data to automatically formulate a travel request in response to the travel request input, the travel request including airline, hotel and rental car reservation information. The processor can automatically create a travel query file by applying business rules to the travel request. These rules include rules for automatically executing an air booking process based on at least two categories of user preference information selected from the group of categories of lowest price, arrival/departure time, airline, non-stop, duration, alternate airports and full fare automobile upgrades. The business rules also include rules for automatically executing a car booking process and automatically executing a hotel booking process. The processor is further programmed to submit the query file to a booking engine for creating a travel request query and to submit the travel request query to the GDS for retrieving air, car and hotel availability information. The processor can receive from the GDS the air, car and hotel availability information and create a suggested travel itinerary and output for display on a user display device the suggested travel itinerary. The processor is programmed to allow manual changes to be made to the suggested travel itinerary, to accept manual confirmation of the suggested travel itinerary and to process data from the confirmed travel itinerary for automatically creating and storing appointment events in a user's calendar application.

The user's computer includes a calendaring application plug-in, or software module, that adds travel request functionality to standard calendar application software. The plug-in provides the user with the capability to initiate a travel request form within the calendar application. The plug-in automatically collects data about the request and formulates a travel request that includes airline, rental car, and hotel reservation requirements for the user's review. A user initiates the automated travel request process by submitting the travel request, which is transmitted to the travel request processor in the host computer system. The travel request processor applies a set of business rules based on previously collected traveler profile information, creates an inquiry consistent with those rules, and forwards it to a GDS for availability retrieval.

Upon availability retrieval by the GDS, suggested itinerary options consistent with the business rules applied by the travel request processor are displayed to the user for review. When user selects from among the options displayed, a confirmation is displayed to the user. Once accepted, the itinerary is booked with the GDS and the plug-in automatically generates appointment events from the itinerary and adds or replaces appointment events in the user's calendar application.

Before the initiation of a travel request, a user provides information pertaining to his or her travel requirements including personal preferences and guidelines consistent with applicable travel policies, such as company travel policies. Included in this information gathering process is a questionnaire-based assessment of a user's patterns of travel, the results of which are used to provide intelligence in the travel availability query formulation process. This information enables the travel request processor to systematically implement an intelligent, efficient, and consistent travel solution most appropriate for the user.

The travel request booking process is automatically performed from the time the user submits his or her travel request until a list of suggested itineraries is returned. The plug-in also, at the user's discretion, automatically calendars the confirmed itinerary's events into the scheduled application.

A method in accordance with the invention includes: maintaining in a computer storage device a database of user profile information including information regarding air travel booking preferences, car booking preferences, hotel booking preferences and personal preference air travel ratings; receiving a travel request input including travel request data gathered from a user's calendar application; using the stored user profile information and the travel request data to automatically formulate a travel request in response to the travel request input, the travel request including airline, hotel and rental car reservation information; and automatically creating a travel query file by applying business rules to the travel request. Application of the business rules includes: automatically executing an air booking process based on at least two categories of user preference information selected from the group of categories of lowest price, arrival/departure time, airline, non-stop, duration, alternate airports and full fare automobile upgrades; automatically executing a car booking process for selecting, and automatically executing a hotel booking process. The method in accordance with the invention also includes: submitting the query file to a booking engine for creating a travel request query; submitting the travel request query to a travel distribution system for retrieving air, car and hotel availability information; receiving from the travel distribution system the air, car and hotel availability information and creating a suggested travel itinerary; outputting for display on a user display device the suggested travel itinerary; allowing manual changes to be made to the suggested travel itinerary; accepting manual confirmation of the suggested travel itinerary; and automatically creating and storing appointment events in the calendar application using data from the confirmed travel itinerary.

The method and system of the invention dramatically reduce the expenditure of time and resources required in order to book business travel and to perform the booking of the travel in an effective manner, consistent with the user's preferences.

### BRIEF DESCRIPTION OF THE DRAWINGS

The accompanying drawings and appendices, which are incorporated in and constitute a part of the specification, illustrate the presently preferred methods and embodiments of the invention and, together with the general description given above and the detailed description of the preferred methods and embodiments given below, serve to explain the principles of the invention.

FIG. 1 shows a block diagram of a computer system suitable for use with the present invention.

FIG. 2 is a simplified functional block diagram illustrating a computer network suitable for practicing the invention including a host computer system, a user computer and a GDS.

FIG. 3 displays an object relationship diagram showing the software objects that can be included in the calendar application plug-in.

FIG. 4 is an example of a screen capture demonstrating the options form used to collect and display user settings.

FIG. 5 is a flow diagram showing the process by which a user requests, books, and calendars travel arrangements.

FIG. 6 is an example of a screen capture demonstrating the appointment form from which the travel request process can be initiated.

FIG. 7 is an example of a screen capture demonstrating a travel request form used to collect and display information that can be used to generate a travel request.

FIG. 8 is an example of a screen capture demonstrating a login screen that can be used to gain access to the host computer system.

FIG. 9 is an example of a screen capture demonstrating a profile page that can be used to provide user profile information to the host computer system.

FIG. 10 is an example of a screen capture demonstrating a start page that can be used to initiate a travel request using the host computer system.

FIG. 11 is an example of a screen capture demonstrating an air booking page that can be used to provide information for booking air travel using the host computer system.

FIG. 12 is an example of a screen capture demonstrating a confirmation page that can be used to display a confirmed travel itinerary to the user.

FIG. 13 is a flow diagram showing the process by which a car can be booked using previously supplied user information.

FIG. 14 is a flow diagram showing the process by which a hotel can be booked using previously supplied user information.

FIG. 15 is a flow diagram showing the process by which confirmed itinerary events are added to a calendar.

### DESCRIPTION

Reference will now be made in more detail to the presently preferred embodiments and methods of the invention as illustrated in the accompanying drawings, in which like numerals refer to like parts throughout the several views.

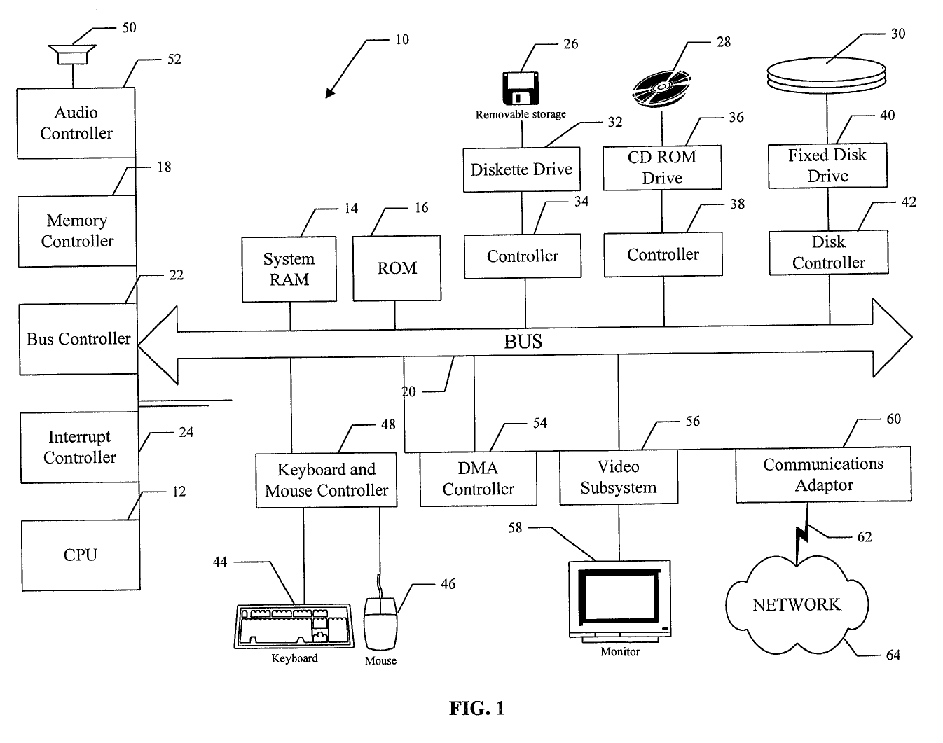

FIG. 1 illustrates the system architecture for an exemplary computer system with which the invention may be used. The exemplary computer system of FIG. 1 is for descriptive purposes only. Although the description may refer to terms commonly used in describing particular computer systems, such as an IBM personal computer, the description and concepts equally apply to other systems, including systems having architectures dissimilar to FIG. 1.

The computer system of FIG. 1 includes a central processing unit (CPU) 12, which may be implemented with a conventional microprocessor, a random access memory (RAM) 14 for temporary storage of information, and a read only memory (ROM) 16 for permanent storage of information. A memory controller 18 is provided for controlling RAM 14. A bus 20 interconnects the components of the computer system of FIG. 1. A bus controller 22 is provided for controlling the bus 20. An interrupt controller 24 is used for receiving and processing various interrupt signals from the system components. Mass storage may be provided by diskette 26, CD ROM 28, or hard drive 30. Data and software may be exchanged with the computer system of FIG. 1 via removable media such as the diskette 26 and CD ROM 28. Diskette 26 is insertable into diskette drive 32, which is, in turn, connected to the bus 20 by a controller 34. Similarly, CD ROM 28 is insertable into CD ROM drive 36 which is, in turn, connected to bus 20 by controller 38. Hard disk 30 is part of a fixed disk drive 40, which is connected to bus 20 by controller 42.

User input to the computer system of FIG. 1 may be provided by a number of devices. For example, a keyboard 44 and a mouse 46 are connected to the bus 20 by a controller 48. An audio transducer 50, which may act as both a microphone and a speaker, is connected to bus 20 by audio controller 52, as illustrated. DMA controller 54 is provided for performing direct memory access to RAM 16.

A visual display is generated by video subsystem 56, which controls video display 58. The computer system of FIG. 1 also includes a communications adapter 60, which allows the system to be interconnected to a local area network (LAN) or a wide area network (WAN), schematically illustrated by a bus 62 and a network 64.

In the presently preferred embodiment of the invention, operation of computer system of FIG. 1 is controlled and coordinated by Windows 98, Windows 2000, Windows NT, or Windows ME operating system software available from Microsoft Corporation. It will be obvious to anyone of ordinary skill in the art that any of several other operating systems may be used to control and coordinate the computer system's operation. These include Unix, Linux, IBM's OS2, or Apple Computer's Macintosh operating systems, to name a few. The operating system controls allocation of system resources and performs tasks such as processing scheduling, memory management, networking, and input/output services, among other things.

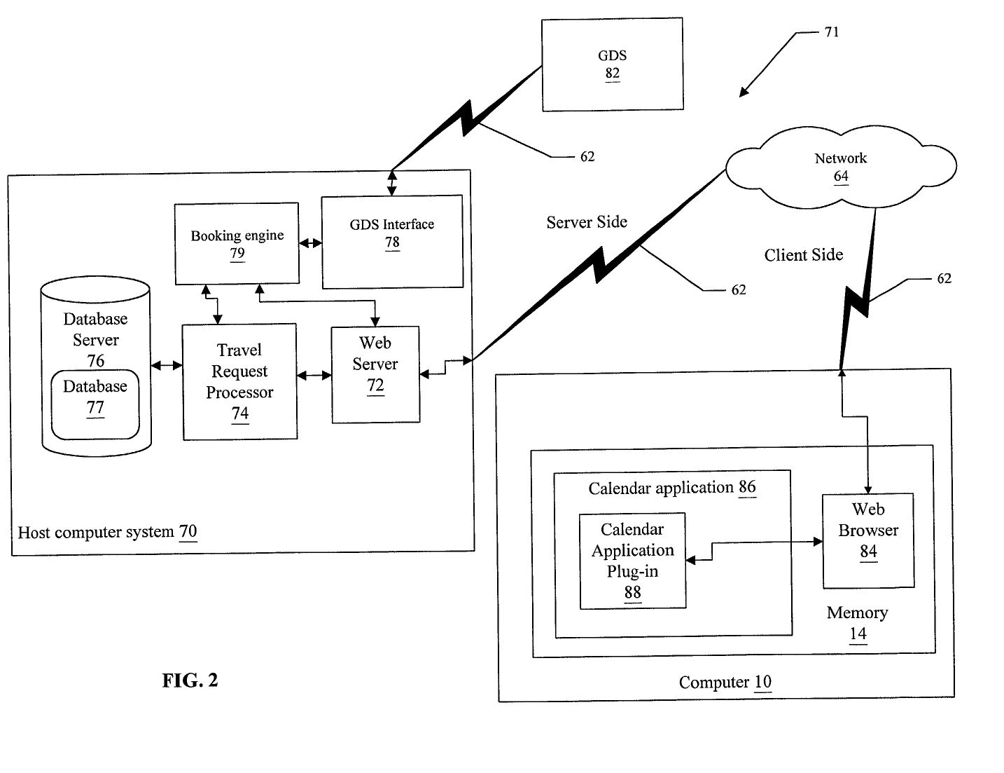

FIG. 2 shows the components of a preferred operating environment, a computer network 71, for the present invention. Referring to FIG. 2, a public network 64 is shown. As described herein, the exemplary public network of FIG. 2 is for descriptive purposes only. Although the description may refer to terms commonly used in describing particular public networks such as the Internet, the description and concepts equally apply to other public and private computer networks, including systems having architectures dissimilar to that shown in FIG. 2.

The computer network 71 of FIG. 2 includes a host computer system 70 and a user computer 10 of the type shown in FIG. 1. It will also be understood the computer 10 may be any device having sufficient attributes of a computer to access the Internet and operate the components on the computer 10 discussed below. Examples of other such devices include Wireless Application Protocol (WAP) devices such as cellular phones and Personal Digital Assistants (PDAs) such as the Palm Pilot produced by Palm, Incorporated.

The host computer system 70 can communicate with the user computer 10 via a communications network 64. The host computer system 70 includes a web server 72, a travel request processor 74, a database server 76, a booking engine 79, and a GDS interface 78. The host computer system 70 is configured in a known manner to communicate over the network 64.

Users can direct user computer 10 to communicate with a network access computer system (not shown), in order to communicate with the application computer system 70 via the communications network 64. The presently preferred communications network 64 includes the Internet. The Internet is a decentralized global network of computers, the structure of which is well known to those skilled in the art, that can communicate with one another using the TCP/IP (transmission control protocol/internet protocol) network protocol. The World Wide Web (the “Web”) is one of several service facilities provided on top of the Internet. The Web provides a somewhat cognitive interface into the Internet. The Web allows users to access information by indicating the location of the information that they desire to retrieve or by traversing hyper-text links which cross-reference information in many different locations.

The communications network 64 can include an Internet Service provider (ISP) computer system that can provide Internet access to users. Examples of Internet service providers include America Online, the Microsoft Network, Cox Communications, and EarthLink, to name just a few. Typically, the network access computer is connected to an Internet routing hub via a high-speed communications link 62. The communication links, in turn, connect to the application computer system 70 via the Internet. When a user desires to access information available on the Internet via the Internet service provider, the user initiates a connection with the ISP computer from user computer 10. For example, the user invokes a web browser 84 that executes on user computer 10. The web browser 84, in turn, establishes a communication link with the Internet service provider computer via a communications link. Once connected to the Internet service provider computer, the user can direct the web browser 84 to access information provided by the application computer system 70. The Internet service provider computer then communicates with the Internet to establish a communications link between the user computer 10 and the application computer system 70.

The host computer system 70 includes a web server 72, a travel request processor 74, a database server 76, a booking engine 79, and a GDS interface 78. In one preferred embodiment, the web server 72, the travel request processor 74, the booking engine 79, and the GDS interface 78 run on one computer and the database server 76 runs on another computer. However, as will be apparent to one of ordinary skill in the art, many combinations of server deployment are possible, and variations exist for server computer systems based on the size of the database, the traffic flow accessing it and the number of customers utilizing the invention. The web server 72 manages network resources and handles all application operations between browser-based user computer 10 and the server side business applications. The travel request processor 74 includes the business application software that implements the business rules of the system. The database server 76 includes a database management system (DBMS), a collection of programs that enables the storing, modification and extraction of information from the database 77. The booking engine 79 is a travel management software program that provides interactive booking capability with the GDS 82 via the GDS interface 78. The GDS interface 78 comprises a hardware interface and the associated Application Programming Interface (API) software that is provided by a GDS to enable the booking engine application to communicate directly with the GDS central system. The GDS 82 communicates in a known manner with its proprietary GDS interface 78 over a high-speed communication link 62.

In the presently preferred embodiment of the invention, the Web server 72 comprises Microsoft Corporation's Internet Information Server software. As will be apparent to one skilled in the art, however, the Web server module can be implemented with any number of other network servers, such as Netscape Communication Corporation's Internet Server software, the publicly available Apache Web server, or WebLogic Server marketed by BEA Systems, Inc. of San Jose, Calif. As is known in the art, such server software can be configured to process messages from user computers and to display electronic pages with information supplied to it. In particular, the Web server 72 can send copies of HTML pages to each user computer that accesses the host computer system 70.

Again referring to FIG. 2, the travel request processor 74 includes the application software that works in cooperation with the processor of the host computer system 70 to process the data in accordance with the rules that define the business logic of the system. It includes the software that, when presented with information obtained from the database 77 and/or user computer 10, systematically applies the business rules in accordance with the present invention. The travel request processor 74 also includes the software to format the results of the application of the business rules into a format that the booking engine 79 can accept. In the presently preferred embodiment of the invention, the travel request processor 74 is implemented by way of software that may be written in any of several languages utilizing object oriented programming methodology. Examples of object-oriented languages include Java, C++, Perl and Visual Basic, among others. As will be understood by those skilled in the art, object-oriented programming techniques involve the definition, creation, use and destruction of “objects.” Objects are software entities comprising data elements, or properties, and methods, or functions, which manipulate the data elements. The properties and related methods are treated as a single entity and can be created, used and deleted as if they were a single item. Together, the properties and methods enable objects to model virtually any real-world entity in terms of its behavior, which can be represented by its data manipulation functions. In this way, objects can model concrete things like people, warehouses, or forms, and they can also model abstract concepts like numbers, geometrical designs, and structured data.

Objects are defined by creating “classes,” which are not objects themselves but which act as templates that provide the information to construct the actual object. A class may, for example, specify the number and type of data variables and the steps involved in the methods that manipulate the data.

When an object-oriented program is compiled, the class code is compiled into the program, but no objects exist. Therefore, none of the variables or data structures in the compiled program exist or have any memory allotted to them until the object is created at runtime. A conversational reference to a class includes all of the objects currently in existence. A class is made up of data types, properties, and methods. Data types correspond to variables of prior programming art. Properties are named groupings of related data items and other structures. Methods correspond to functions and subroutines of prior programming art.

The principle benefits of object-oriented programming techniques arise out of three basic principles: encapsulation, polymorphism and inheritance. More specifically, objects can be designed to hide, or encapsulate, all, or a portion of, the internal data structure and the internal functions. More particularly, during program design, a program developer can define objects in which all or some of the attributes and all or some of the related functions are considered “private” or for use only by the object itself. Other data or functions can be declared “public” or available for use by other programs. Access to the private variables by other programs can be controlled by defining public functions for an object that access the object's private data.

Polymorphism is a concept that allows objects and functions having the same overall format, but which work with different data types, to function differently in order to produce consistent results. For example, an addition function may be defined as variable A plus variable B (A+B) and this same format can be used whether the A and B are numbers, characters or dollars and cents. However, the actual program code that performs the addition may differ widely depending on the data types that comprise A and B. Polymorphism allows three separate function definitions to be written, one for each data type (numbers, characters, and dollars). After the functions have been defined, a program can later refer to the addition function by its common format (A+B) and, at runtime, the program will determine which of the three functions is actually called by examining the data types. Polymorphism allows similar functions that produce analogous results to be “grouped” in the program source code to produce a more logical and clear program flow.

The third principle that underlies object-oriented programming is inheritance, which allows program developers to easily reuse pre-existing programs and to avoid creating software from scratch. The principle of inheritance allows a software developer to declare classes (and the objects that are later created from them) as related. Specifically, classes may be designated as subclasses of other base classes. A subclass “inherits” and has access to all of the public functions of its base class just as if these functions appeared in the subclass.

As previously noted, the implementation of object-oriented technology forms the basis for travel request processor 74 of the present invention. In one advantageous embodiment of the travel request processor, the objects conform to an object model such as Microsoft's Component Object Model (COM). It will be understood, however, tht other suitable object models, such as IBM Corporation's System Object Model (SOM), also may be utilized for implementing travel request processor 74. The Component Object Model (COM) provides a system that describes how to create and communicate with objects, how to store them, how to label to them, and how to exchange data with them, which enables programmers to develop objects that can be accessed by any COM-compliant application. COM is a technology that allows the creation of an object in any object-oriented language, making the functionality of that object available to any other object, or any other application, regardless of the language in which the other object or application is written. For more information on the Component Object Model, see The COM Specification, Microsoft Corporation (1995), which is incorporated herein by reference.

This COM object may be written in any language desired (C++, Java, Perl, Visual Basic, etc.) but because it conforms to the COM specification, it will be available as a resource to any COM-compliant application. Accordingly, the implementation of the travel request processor 74 may be accomplished using any of the object-oriented programming languages in any combination. It will be apparent to one of ordinary skill in the art that a plethora of deployments are available with which to implement the invention, each with advantages over the other, depending on the intended use of the invention and the environment in which it exists. The object model is useful in contexts where all objects in a given system need to conform to a given protocol governing their interaction. Most object-oriented and object-based languages do not specify true object modules, but merely specify syntax and semantics of a basic object implementation without specifying the rules that unify object systems.

Microsoft Corporation has also published an Object Linking and Embedding (OLE) specification, which defines the rules regarding linking and embedding of objects that conform to the COM specification. OLE is a set of system-level services that utilize the interfaces defined by the COM specification. These services are implemented as a series of OLE libraries in the form of Dynamic Link Libraries (DLLs), libraries of executable functions or data, that come with the Microsoft Windows operating system and supply built-in services that perform generalized, low-level tasks. A DLL can be used by several applications at the same time. Custom DLL's can also be written for a particular application to act as a container for the objects that implement the application.

Still referring to FIG. 2, the database server 76 comprises a database management system (DBMS). The preferred database management system (DBMS) is a relational DBMS (RDBMS), which stores data in the form of related tables. Relational databases require few assumptions about how data is related or how it will be extracted from the database. As a result, the same database can be viewed in many different ways. An important feature of RDBMSs is that a single database can be spread across several tables. This differs from flat-file databases, in which each database is self-contained in a single table.

In the present embodiment of the invention, the database server 76 is implemented using Microsoft Corporation's Visual FoxPro database development system. As will be apparent to one skilled in the art, however, the database can be implemented with any number of commercial database programs, including relational database products such as the Oracle database products from Oracle Corporation, Microsoft Corporation and Sybase Corporation's SQL Server DBMS, and the DB2 database products from IBM, to name a few examples.

The preferred database 77 is any ANSI standardized, SQL compatible, relational database. SQL (an abbreviation of “structured query language”) is a standardized query language for requesting information from a database. Historically, SQL has been a standard query language for database management systems running on minicomputers and mainframes. Increasingly, however, SQL is being supported by PC database systems because it supports distributed databases (databases that are spread out over several computer systems). This enables several users on a local-area network to access the same database simultaneously. The American National Standards Institute (ANSI) has standardized SQL as its official query language for databases in ANSI X3.135-1992 (R1998), “Information Systems—Database Language—SQL”. The extraction, storage and use of data stored in the aforementioned relational database is routinely accomplished by one skilled in the art.

In a preferred embodiment, the booking engine 79 is implemented using the cytric® application available from i:FAO of North America, Inc. of Dearborn, Mich. The booking engine software 79 utilizes the results of the travel request processor's intelligence to formulate complex queries of the GDS 82 and perform such functions as the automation of repetitive tasks. In addition, the booking engine 79 provides a Web-based interactive travel booking application whose functionality may be accessed by the user directly via his Web browser 84. Other commercially available travel management software suitable for the booking engine 79 includes the i-traveldirect travel management application from Equant N.V. of the Netherlands. As will be apparent to one of ordinary skill in the art, any of these commercially available applications can be integrated into the host computer system 70.

The GDS 82 of the presently preferred embodiment of the invention is available from Sabre Inc. of Fort Worth, Tex. The GDS interface 78 of the presently preferred embodiment, which comprises a hardware interface and the associated API software, also is available from Sabre, Inc. The API is available to download via an Internet connection to users of the Sabre GDS, and the hardware, which is integrated into the host computer system in a manner known in the art, is provided to subscriber's to the Sabre service. In the presently preferred embodiment of the invention, a dedicated telephone line provides the communication link 62 between the GDS 82 and the GDS interface 78. Communication is accomplished in accordance with the CCITT's X.25 interface protocol for packet-switched public networks. As will be apparent to one of ordinary skill in the art, other suitable GDSs, including those available from Worldspan, L.P. of Atlanta, Ga., Amadeus Global Travel Distribution SA of Madrid, Spain, and Galileo International of Rosemont, Ill., offer a variety of API solutions for the GDS interface 78 implementation, including those that utilize the Internet as the communication link. The use of these GDS interfaces is well-known in the art and the implementation if the GDS interface 78, therefore, is not limited to the specific details, representative devices, and illustrative examples shown and described. Accordingly, departures may be made from such details without departing from the spirit or scope of the general inventive concept.

Referring again to FIG. 2, the user computer 10 includes software for a web browser 84, a calendar application 86, and a calendar application plug-in 88, all stored in memory 14. The web browser utilized in the presently preferred embodiment of the invention is Microsoft Corporation's Internet Explorer. Another suitable Web browser is Netscape Communication Corporation's Navigator browser. The calendar application 86 employed in the present invention is Microsoft Corporation's Outlook. Lotus Development Corporation's Lotus Notes and eCal Corporation's eCal are examples of other calendar application software suitable for implementing the calendar application 86. The calendar application 86 enables the user to record events and appointments on an electronic calendar and provide additional features including, for example, automatic entries for regular events and signaling of upcoming events, to name a few.

The calendar application plug-in 88 incorporates the automatic travel arrangement planning and calendaring features into the calendar application 86. The software that implements the plug-in functionality is stored in memory 14 on the user's computer 10 after the execution of an installation program. This installation program is downloaded to the user computer 10 via an Internet connection with the host computer system 70. The calendar application plug-in 88 prepares a travel request using information provided by the user and obtained from the calendar application 88. It also includes the logic that, upon the return of a confirmed itinerary, manages the addition of the associated appointment events into the user's calendar.

In one advantageous embodiment of the invention, the calendar application plug-in 88, like the travel request processor 74 employs software that utilizes object oriented programming methodology. In conjunction with the use of object oriented programming techniques, the use of scripting languages such as Microsoft's Corporation's VBScript and Netscape Communication Corporation's JavaScript provide a means to embed programmatic logic into HTML files that will be dynamically interpreted when the HTML page is processed by the web server 72. As is known in the art, this embodiment effects efficient web enabled form processing.

It will be apparent to one of ordinary skill in the art that the invention can be used in a variety of other network architectures. As described herein, the exemplary network architecture is for descriptive purposes only. Although the description may refer to terms commonly used in describing particular computer system architectures, such as client-server architectures, the description and concepts equally apply to other computer systems, including systems having architectures dissimilar to that shown in FIG. 2.

A user adds the plug-in 88 to the calendar application 86 resident on the user computer memory 14 by navigating to the host web site and downloading plug-in installation files. After the installation files have been downloaded, the user executes an installation program contained in the downloaded files that installs the plug-in 88 into the calendar application 86. The Outlook calendar application used in the presently preferred embodiment of the invention supports plug-ins as part of it's overall architecture. The Outlook application actively searches for plug-ins when it initializes. If a plug-in is found that is designated an autostart plug-in, the Outlook application loads it. The calendar-plug-in 88 of the presently preferred embodiment of the invention has been designated as an autostart plug-in and is designed in accordance with the publication How To: Build an Office 2000 COM Add-In in Visual Basic, Microsoft Corporation (2001), which is incorporated herein by reference.

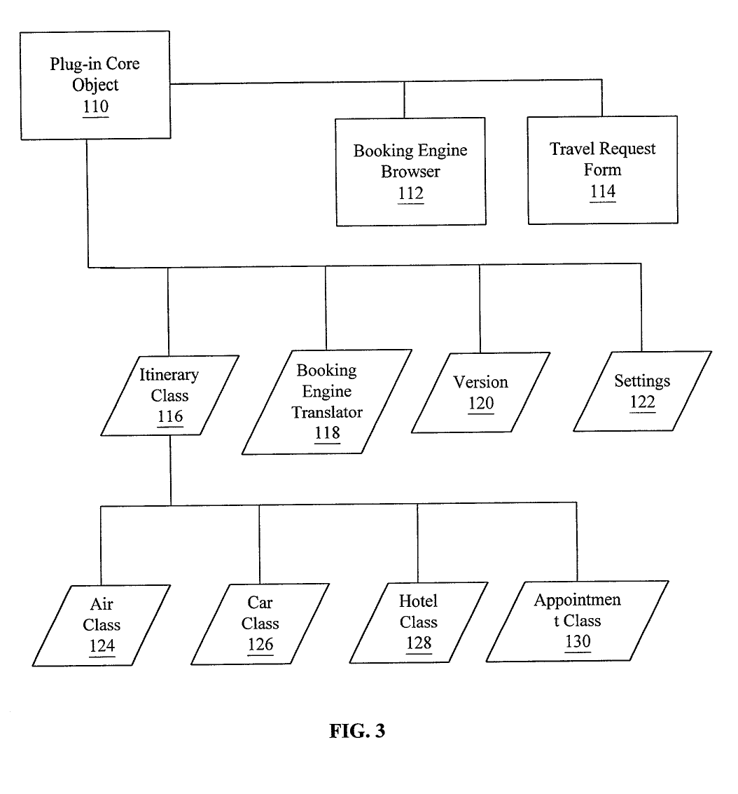

As previously mentioned, the plug-in 88 is implemented using software employing object oriented methodology. The plug-in 88 comprises objects that provide its functionality. FIG. 3 illustrates the relationship among the objects of the plug-in 88. The plug-in core object 110 provides the interface with the calendar application 86 and generates the settings object 122 and the version object 120 as public sub-objects. The version object 129 includes information about the calendar application's software release and version, the plug-in's software release and version, and the compatibility between the two. The core object 110 also contains the itinerary class 116 as a private class and the booking engine translator 118 as a private object. The core object 110 creates an instance of the itinerary class 116 using the booking engine translator 118 which splits the confirmed itinerary received from the GDS 82 via the booking engine 79, allowing the creation of an itinerary object. The itinerary class 116 contains the air class 124, the car class 126, the hotel class 128, and the appointment class 130 as public classes. An itinerary object may have multiple instances of each of an appointment object, an air object, a car object, and a hotel object. The core object 110 uses the booking engine browser 112 to pass travel request information contained in the travel request form 114 to the host computer system 70 for processing. The booking engine browser is an instance of the web browser 84 under control of the core object 110.

The interface between the calendar application 86 and the plug-in 88 in the presently preferred embodiment of the invention is summarized in the following tables. Table 1 lists methods invoked by the core object 110, the parameters supplied to the core

TABLE 1

| | Parameter Supplied by | |
|---|---|---|
| Core Object Method and | the | |
| Description | Calendar Application | Parameter Type |
| Display Itinerary List-- | XML flag | Boolean-true indicates response |
| retrieves for display to the | | must be in XML format |
| user and/or processing by the | Itinerary ID | String-unique ID for a specific user |
| core object confirmed | | and itinerary . . . assigned by booking |
| itineraries as a summarized | | engine |
| list | Login value | String |
| | Password | String |
| | Portal ID | String-identifies server, booking |
| | | engine instance, and customer |
| | | division to user |
| Display Itinerary--retrieves | XML flag | Boolean |
| a confirmed itinerary for | Login value | String |
| display to the user and/or | Password | String |
| processing by the core object | Portal ID | String |
| Start Air-initiates the | Display Travel Request | Boolean |
| booking process when user | flag | |
| submits travel request | Start Date | Date |
| | End Date | Date |
| | One-way flag | Boolean |
| | City 1 | String |
| | City 2 | String |
| | Arrival Date 1 flag | Boolean |
| | Arrival Date 2 flag | Boolean |
| | Login value | String |
| | Password value | String |
| | Portal ID | String |
| | Save Options flag | Boolean |
| | Prompt to add | Integer-one of three choices |
| Cancels Itinerary-cancels | Itinerary ID | String |
| a confirmed itinerary | Login value String | |
| | Portal ID | String |
| | Plug-in Version | String |
| Check Version-checks the | AppName | String |
| application name and version | VersionInfo | String |
| New User-invoked when | Login value | String |
| a new user is indicated | Password value | String |
| | Portal ID | String |
| | Save Options flag | Boolean |

object 110 by the calendar application 86, and the parameter types. Table 2 lists events detected by the core object 110, the parameters supplied by the calendar application 86, and their parameter types.

TABLE 2

| | Parameter Supplied | |
|---|---|---|
| Core Object Events and | to the | |
| Description | Calendar Application | Parameter Type |
| Itinerary List XML- | XML | String |
| indicates the core object | | |
| has received an itinerary | | |
| list formatted in XML | | |
| Itinerary XML-indicates | XML | String |
| the core object has received | | |
| an itinerary formatted in | | |
| XML | | |
| Itinerary Cancelled- | XML | String |
| indicates an itinerary has | Booking Code | String-code assigned to a |
| been cancelled | | passenger's itnerary by the |
| | | booking engine |
| New Appointment- | Start Date | Date |
| indicates an appointment is | Start Time | String |
| to be added to the calendar | End Date | Date |
| | End Time | String |
| | All Day flag | Boolean-indicates the |
| | | appointment to be an all day |
| | | event |
| | Subject | String-title of calendar entry |
| | Body | String-body of calendar entry |
| | Booking Code | String |
| | Itinerary ID | String |

Reference is made in Table 1 and Table 2 to XML. In the presently preferred embodiment of the invention, data may be stored or transferred as XML documents or as XML text strings. XML, short for Extensible Markup Language, is a specification developed by the World Wide Web Consortium (W3C), an international consortium of companies involved with the Internet and the Web that was founded in 1994 and whose purpose it is to develop open standards for Web development. XML is a structured method for putting data in a standardized text format designed specifically for transmitting structured data to web applications. An XML document is composed of data embedded within an unlimited number of author-defined markup tags that define the internal structure of the embedded data and is similar to a database containing records and fields. The data is in the form of a text string. The author-defined tags define the internal structure of the embedded attributes based upon rules set forth in a separate document known as the DTD, or Document Type Definition.

The XML specification describes XML documents, and partially describes the behavior of XML processing programs used to read XML documents and provide access to their content and structure. Currently available web browsers including Microsoft's Internet Explorer and Netscape's Navigator, to name two, include XML parsers that provide these browsers with their XML functionality. The parsers are programs that read the XML file and make available the data in the files. Because XML is an open specification, documentation, parsers, and support software are readily available from a multitude of commercial sources. As will be apparent to one of ordinary skill in the art, data transfer can be implemented in a variety of languages other than XML and using a variety of structures to transfer data throughout the system.

In one advantageous embodiment of the invention, the parser employed supports the XML Document Object Model (DOM). The W3C's DOM Level I Specification for XML is an object model that defines the logical structure of documents and the way a document is accessed and manipulated. The DOM defines a standard set of commands that parsers expose in order that programmers can access XML document content with their programs. The DOM is a platform-independent and language-neutral interface that allows software programs to dynamically access and update the content and structure of documents. In the context of the present invention, the DOM is an object model that specifies how XML documents are represented as objects so they may be used in object-oriented software programs. W3C's DOM is an open specification and documentation and support software are readily available from a wide variety of commercial sources.

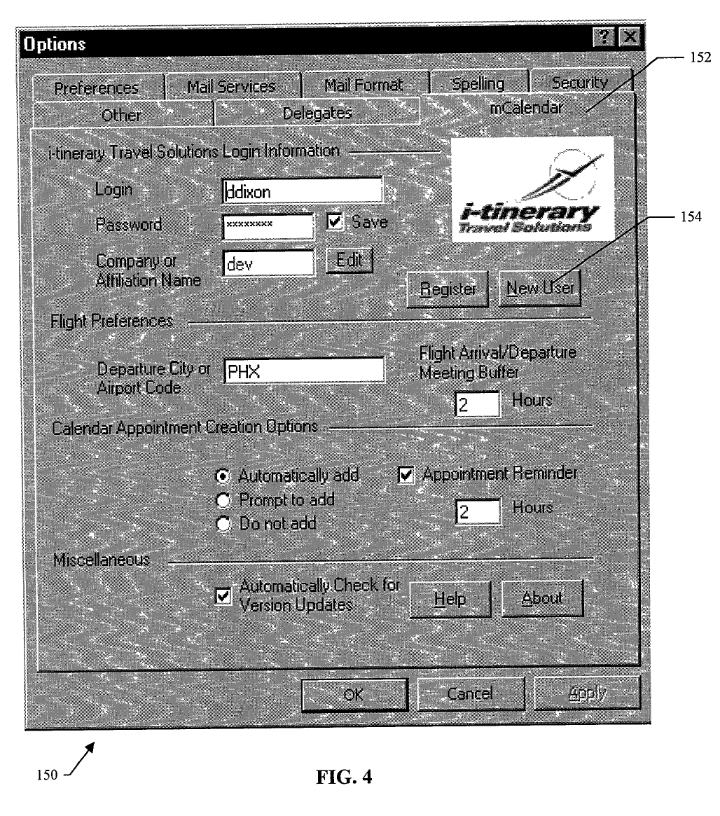

FIG. 4 depicts a screen capture of the calendar application's options form 150 after the plug-in 88 has been installed in the presently preferred embodiment of the invention. The user accesses the options form 150 by selecting the options button in the calendar application 86 and then selecting the tab 152 associated with the plug-in. The information supplied by the user in this form includes those items listed in Table 3. Many of these listed items may initially be provided during the plug-in installation process. This information is stored in the settings object 122 for future use or modification. New User button 154 provides a new user with ability to create a travel profile from the calendar application 86 by launching the booking engine browser 112 and accessing the web site of the host computer system 70. Alternatively, the user can create or modify the travel profile by accessing the host computer system 70 using the web browser 84. The user navigates to the appropriate page of the web site and follows the instructions for creating or modifying the travel profile.

TABLE 3

| Input Name | Description | Data Source |
|---|---|---|
| Login | Login ID. Text field. | User defined--pre- |
| | | installation |
| Save Password | Check box. | User defined--pre- |
| | | populated during |
| | | installation |
| Company or Affiliation | Traveler's company name or | User defined--pre- |
| Name | affiliation (portal/website affiliation), | populated during |
| | Text field. | installation |
| Update | Check box. | Default is |
| | | unchecked. |
| Departure Airport | Default departure airport. Text field. | User defined--pre- |
| | | populated during |
| | | installation |
| Flight Arrival/Departure | Used to add an arrival and departure | User defined--pre- |
| Meeting Buffer | time buffer to the meeting times when | populated during |
| | searching for flights. (E.g. 2 hours | installation--Default |
| | before & 2 hours after meeting). Text | is 2 hours |
| | field. | |
| Automatically Add/Prompt | Radio Button-- one of “Automatically | User defined--pre- |
| to Add/Do Not Add | Add”, “Prompt to Add”, or “Do Not | populated during |
| | Add” | installation |
| Appointment Reminder | Check-box | User defined--pre- |
| | | populated during |
| | | installation |
| Appointment Reminder | Used to indicate the hour(s) prior to an | User defined--pre- |
| Hours | appt. an alert should be set for. Text | populated during |
| | box. | installation |
| Check For Updates | Check-box, to check for new versions | User defined--pre- |
| | of the add-in | populated during |
| | | installation |

Table 4 lists the properties and variable types of the itinerary class 116.

TABLE 4

| Property | Type |
|---|---|
| Booking Code | String |
| Itinerary ID | String |
| Booking Date | Date |
| Fare | String |
| Address | String |
| Air Collection | Object |
| Car Collection | Object |
| Hotel Collection | Object |
| Appointment Collection | Object |

Table 5 lists the properties and variable types of the air class 124.

TABLE 5

| Property | Type |
|---|---|
| Flight Number | String |
| Depart City | String |
| Depart Date | Date |
| Depart Time | Date |
| Arrival City | String |
| Arrival Date | Date |
| Arrival Time | Date |
| Class | String |
| Airline | String |
| Seat | String |
| Gate | String |
| Connecting City | String |
| Text Local | String |

Table 6 lists the properties and variable types of the car class 126.

TABLE 6

| Property | Type |
|---|---|
| PickUp Location | String |
| Depart Date | Date |
| Depart Time | Date |
| DropOff Location | String |
| Arrive Date | Date |
| Arrive Time | Date |
| Company | String |
| Type of car | String |
| Rate | String |
| Confirmation | String |
| Text Local | String |

Table 7 lists the properties and variable types of the hotel class 128.

TABLE 7

| Property | Type |
|---|---|
| CheckIn Time | Date |
| CheckOut Time | Date |
| Name | String |
| Address | String |
| City | String |
| Zip | String |
| Room | String |
| Rate | String |
| Confirmation | String |
| Text Local | String |

Table 8 lists the properties and variable types of the appointment class 128.

TABLE 8

| Property | Type |
|---|---|
| DateStart | Date |
| DateEnd | Date |
| TimeStart | Date |
| TimeEnd | Date |
| AllDayEvent | Boolean |
| Subject | String |
| Body | String |

Tables 9 through 13 list travel profile parameters. These tables list the name and description of the input and the source from which the input is derived. The user profile is stored in the database 77 of the host computer system 70 for use in the travel booking process. Table 9 lists travel profile parameters associated with the user's air travel booking preferences.

TABLE 9

| Input Name | Description | Data Source |
|---|---|---|
| Accept Penalties/ | Accept fares which penalize the customer for | User Defined |
| Restrictions | changes to a fare. Accept restricted fares. | Default = Y |
| Class Pricing | Indicates whether the traveler desires to make | User Defined |
| Option | pricing comparisons across classes. | Default = N |
| Arrival/Departure | Information used when Specific Matrix | User Defined |
| Time | Generated Requirements (SmGR) dictate A/D | |
| | times are important to the traveler. | |
| Request Buffer | The maximum time variance on either side of | User Defined |
| Window | a requested departure or arrival time that a | |
| | traveler will accept when taking a flight. | |
| Arrive Before | Before requested arrival time. | User Defined: |
| | | Default = 1 hour |
| Arrive After | After requested arrival time. | User Defined: |
| | | Default = 1 hour |
| Depart Before | Before requested departure time. | User Defined: |
| | | Default = 1 hour |
| Depart After | After requested departure time. | User Defined: |
| | | Default = 1 hour |
| Airlines | Information used when SMGR dictate use of | User Defined |
| | preferred Airlines are important to the traveler. | |
| Preferred Airlines | Airlines on which the traveler prefers to fly. | User Defined |
| | Rank in order of preference. | |
| Fare Savings | Dollar amount field indicating the minimum | User Defined |
| Minimum | savings that must be realized before SMGR | |
| | will be overridden to take a lower priced fare | |
| | (Alternate Airports, Class Savings, Penalty | |
| | and Restrictions) | |
| Fare Increase | Dollar amount field indicating the maximum | User Defined |
| Maximum | price increase that user is willing to pay in | |
| | order to change Class of Service. | |
| Preferred Airline | First, Business, Coach, Economy. Cardinality | User Defined: |
| Class | = 0, 1 | Default = Coach |
| Preferred | Default departure airport. | User Defined |
| Departure Airport | | |
| Passenger Type | Adult, Child, Military, Senior | User Defined: |
| | | Default = Adult |
| Seat Preference | Window, Aisle | User Defined: |
| Within Row | | Default = Aisle |
| Seat Preference | Front, Back | User Defined: |
| Within Aircraft | | Default = Blank |
| Vendor Programs | List of programs to which traveler belongs | User Defined |

Table 10 lists travel profile parameters associated with the user's car booking preferences.

TABLE 10

| | | Data |
|---|---|---|
| Input Name | Description | Source |
| Car Type | Drop down list, select 0, 1-3 prioritized. | User |
| Preference | | Defined: |
| | | Default = |
| | | Midsize |
| Preferred Car | 0,1-n: Car Rental Companies which the | User |
| Rental Companies | traveler prefers to rent from. | Defined |

Table 11 lists travel profile parameters associated with the user's hotel booking preferences.

TABLE 11

| Input Name | Description | Data Source |
|---|---|---|
| Maximum Price | Maximum price traveler will pay per night. | User Defined: |
| | | default = Blank |
| Location | Airport, City | User Defined: |
| | | Default = Airport |
| Preferred Hotel | 0,1-n: Hotel Chains which the traveler prefers | User Defined |
| Chains | to stay at. Rank in order of preference | |
| Hotel Room Type | Single or Double Occupancy. | User Defined |
| | | Default = Single |
| | | Occupancy |
| Room | Single Bed (defined as Twin) or Double Bed | User Defined |
| Accommodations | (defined as King or Queen) | Default = Double |
| | | Bed |
| Discount Rates | AARP, AAA, Corporate, None | User Defined |
| | | Default = None |

Table 12 lists parameters associated with the booking of the travel and the calendaring of the itinerary.

TABLE 12

| Input Name | Description | Data Source |
|---|---|---|
| One Click Auto | Check box. Defines whether itineraries | User Defined: |
| Book | created from the One Click process will | Default = Y |
| | automatically be booked or whether the user | |
| | will be prompted with the potential itinerary | |
| | information. | |
| Calendar Meeting | The default number of hours before and | Calendar Application |
| Buffer | after a meeting that a traveler wishes to | Options form |
| | arrive then depart from the destination city. | |

Table 13 lists personal preference information used in the intelligent booking of air travel.

TABLE 13

| | | Data |
|---|---|---|
| Input Name | Description | Source |
| Low Price | On a scale of 1-5 how important the lowest | User |
| | price is within selected class | Rated, |
| | | default = |
| | | 1 |
| Alternate | On a scale of 1-5 how important the use of | User |
| Airports | alternate Airports to obtain either flights with | Rated, |
| | lowest price or those with flights closest is to | default = |
| | the preferred arrival/departure time | 1 |
| Arrival/ | On a scale of 1-5 how important it is to arrive | User |
| Departure | or depart at the indicated time | Rated, |
| Time | | default = |
| | | 1 |
| Non-stop | On a scale of 1-5 how important it is to avoid | User |
| | multiple connecting flights when traveling, | Rated, |
| | Restrictions may increase overall cost of flying | default = |
| | | 1 |
| Duration | On a scale of 1-5 how important it is to take | User |
| | the routes or flights which will result in the | Rated, |
| | shortest total duration, including time between | default = |
| | connections of flights | 1 |
| Airline | On a scale of 1-5 how important it is to fly on | User |
| | the preferred Airlines | Rated, |
| | | default = |
| | | 1 |
| Full Fare | On a scale of 1-5 how important it is to take | User |
| Auto | advantage of Full Fare Automatic Upgrades | Rated, |
| Upgrades | offered universally by the airlines | default = |
| | | 1 |

Scale where 1 = Not Important, 5 = to Important

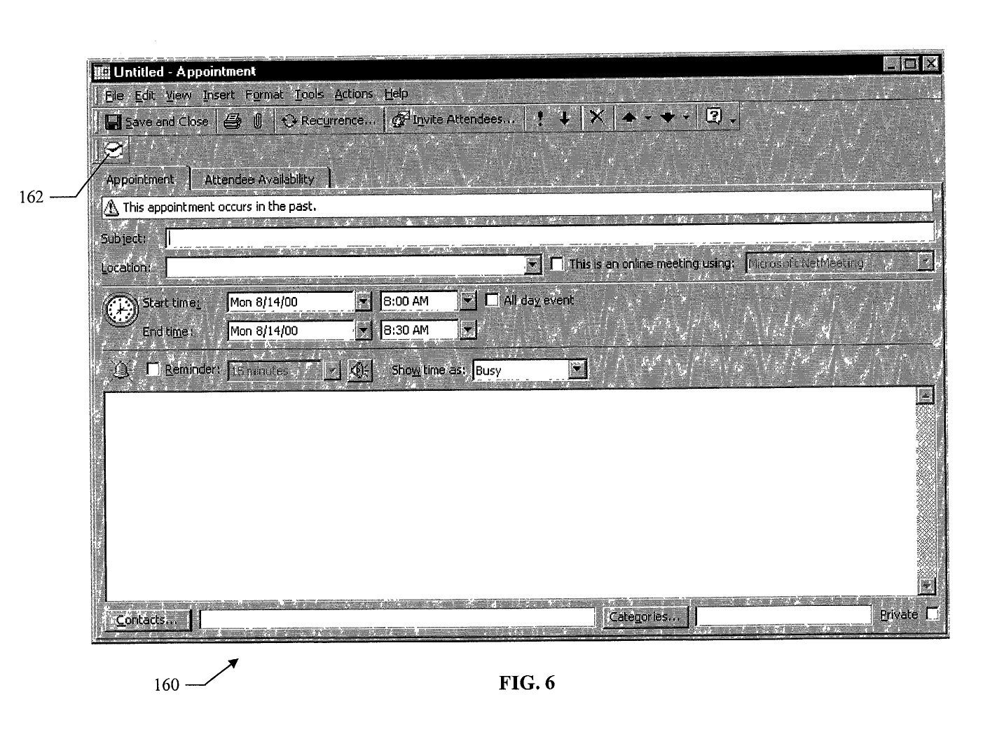

FIG. 6 shows a screen capture of the appointment form 160 displayed by the calendar application 86 of the presently preferred embodiment of the invention. The host icon 162 is displayed on the form. The user clicks on the icon 162 to initiate the travel request process.

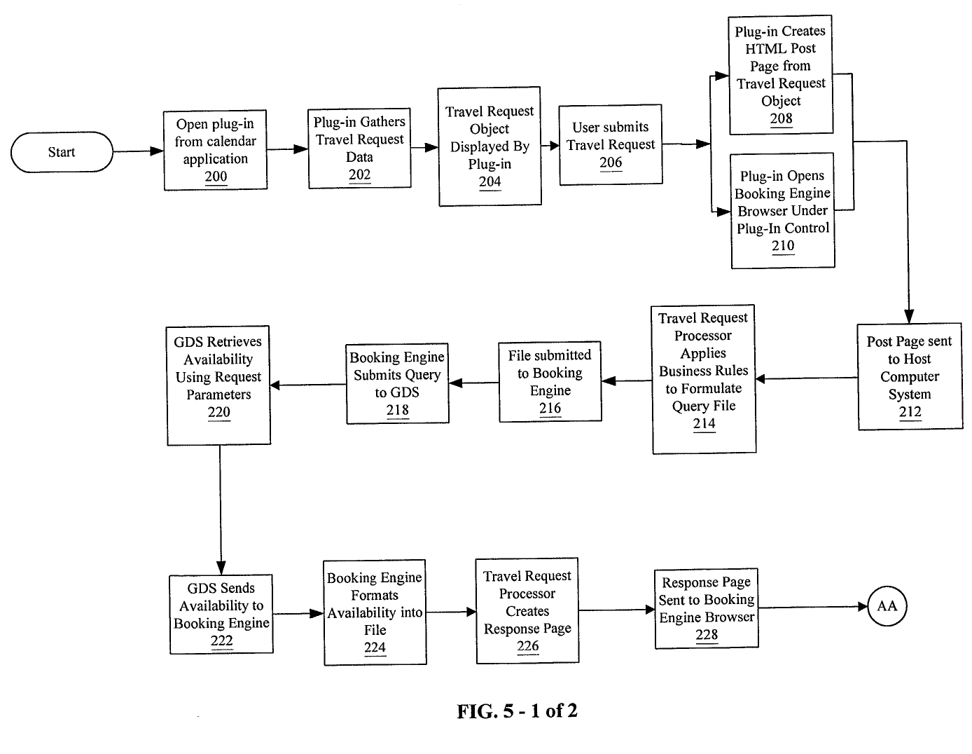

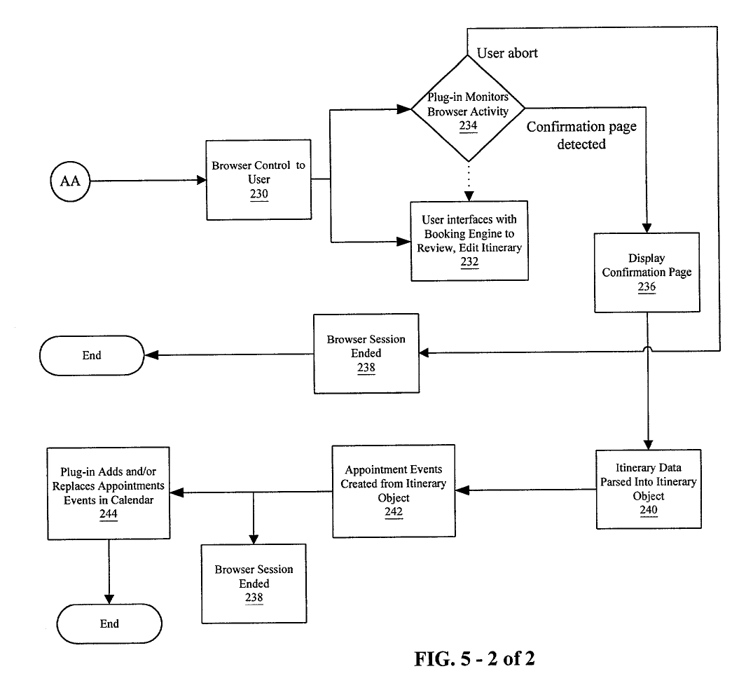

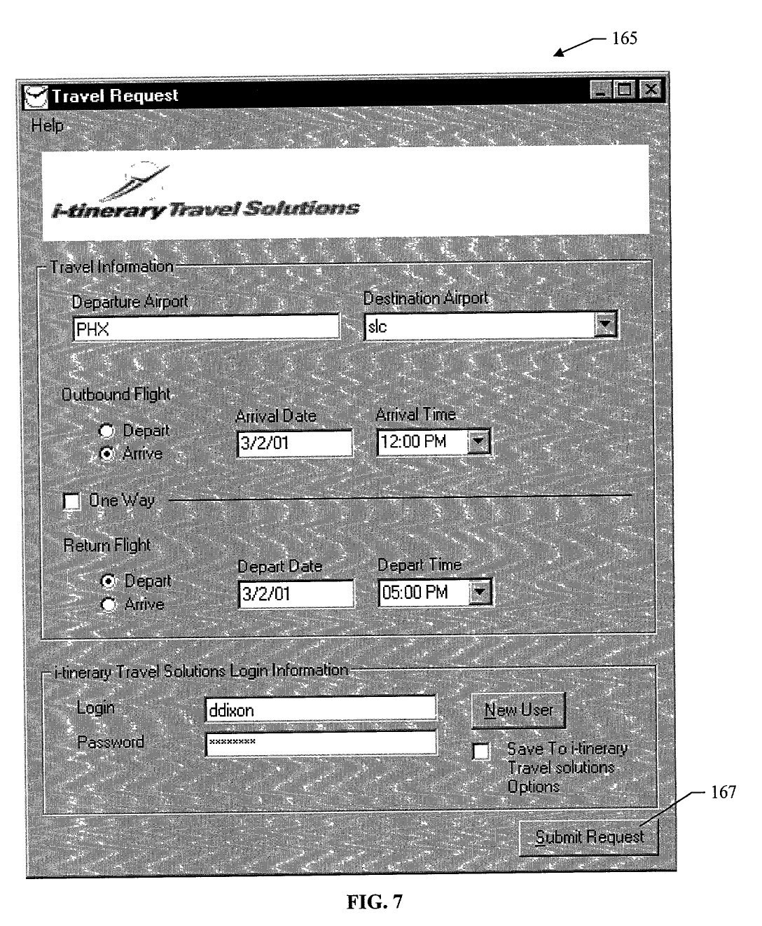

FIG. 5 illustrates the method by which a user applies the invention. By clicking the icon 160, the user opens the plug-in (step 200). The plug-in 88 gathers travel request data (step 202) from the calendar application 86, the settings object 122 (including the information listed in Table 3), and displays the travel request form to the user (step 204). FIG. 7 shows the travel request form 165 displayed to the user. The user supplies the remainder of the information not already shown by the travel request form 165, and submits the travel request (step 206) by clicking the submit request button 167. The information listed in Table 14 is included in the travel request object 114. Referring again to FIG. 5, the plug-in 88 then creates an HTML post page using the information listed in Table 14 and contained in the travel request object (step 208). The plug-in also opens the booking engine browser, which is under control of the plug-in (step 210). The HTML page is posted to the host computer system (step 212). In the presently preferred embodiment of the invention, Microsoft's Active Server Pages (ASP) captures the XML data contained in the HTML post page, the implementation of which is readily know to someone of ordinary skill in the art. In addition, it will be obvious to anyone skilled in the art that the processing of HTML content by the host computer system 70 may be accomplished using variety of techniques, any of which would be consistent with the objects of the present invention.

TABLE 14

| Name | Description | Data Source |
|---|---|---|
| Departure Airport | Departure Airport. | User defined--pre-populated |
| | Text box. | from Options object |
| Destination Airport | The destination airport | User defined--pre-populate list |
| | Combo box. | from the calendar appointment |
| | | screen location field and then |
| | | from the City Field of each |
| | | contact associated with the |
| | | appointment. |
| Outbound Departure or | Time combo box | Initially calculated-Start |
| Arrival Time | | Time from calendar |
| | | appointment minus Flight |
| | | Buffer from Options object |
| Outbound Departure or | Date text box | Initially calculated-- Start |
| Arrival Date | | Time and Date from calendar |
| | | appointment minus Flight |
| | | Buffer from Options object |
| Outbound | Radio button-“Arrival” | User defined |
| Arrival/Departure | or “Departure” | |
| One-way Flight | Check-box | User defined--default is |
| | | unchecked |
| Return Departure or | Time combo box | Initially calculated-End Time |
| Arrival Time | | from calendar appointment |
| | | plus Flight Buffer from |
| | | Options object |
| Return Departure or | Date text box | Initially calculated-- End Time |
| Arrival Date | | and Date from calendar |
| | | appointment plus Flight Buffer |
| | | from Options object |
| Return Arrival/Departure | Radio button-“Arrival” | User defined |
| | or “Departure” | |
| Login | Login ID. Text field. | User defined--pre-populated |
| | | from install program |
| Password | Login password. Text | User defined--pre-populated |
| | field. | from install program |
| Company or Affiliation | Traveler's company | User defined--pre-populated |
| Name | name or affiliation | from install program |
| | (portal/website | |
| | affiliation). Text field. | |
| Save To Options | Checkbox, used to save | User defined--default blank |
| | data from the Travel | |
| | Request object to the | |
| | Options object | |

The web server 72 routes the information in the post to the travel request processor 74, which applies business rules to formulate a travel request query file (step 214). The application of these business rules uses the traveler profile information stored in the database 77 and includes the information listed in Tables 9 through 13.

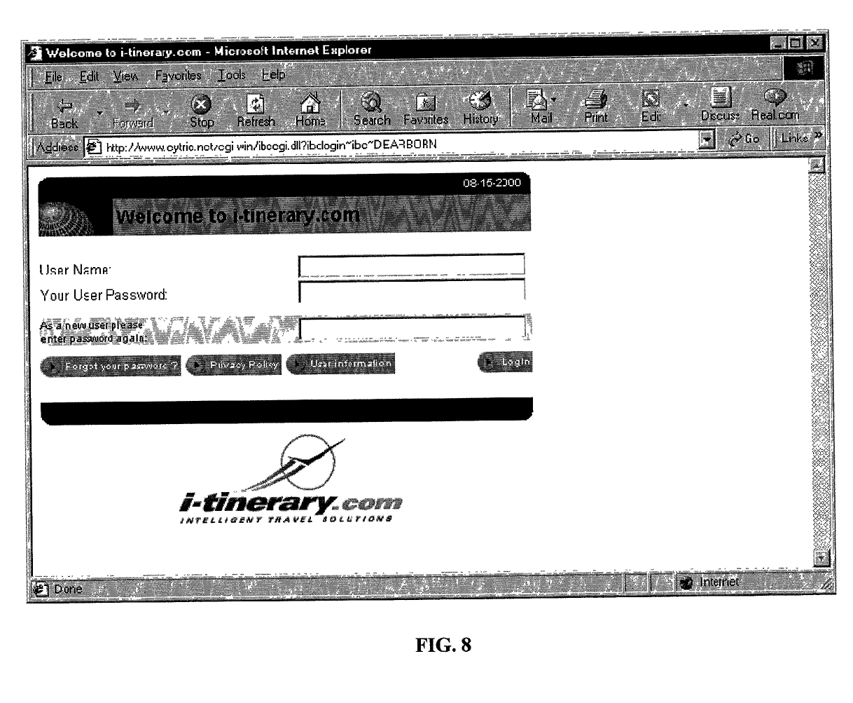

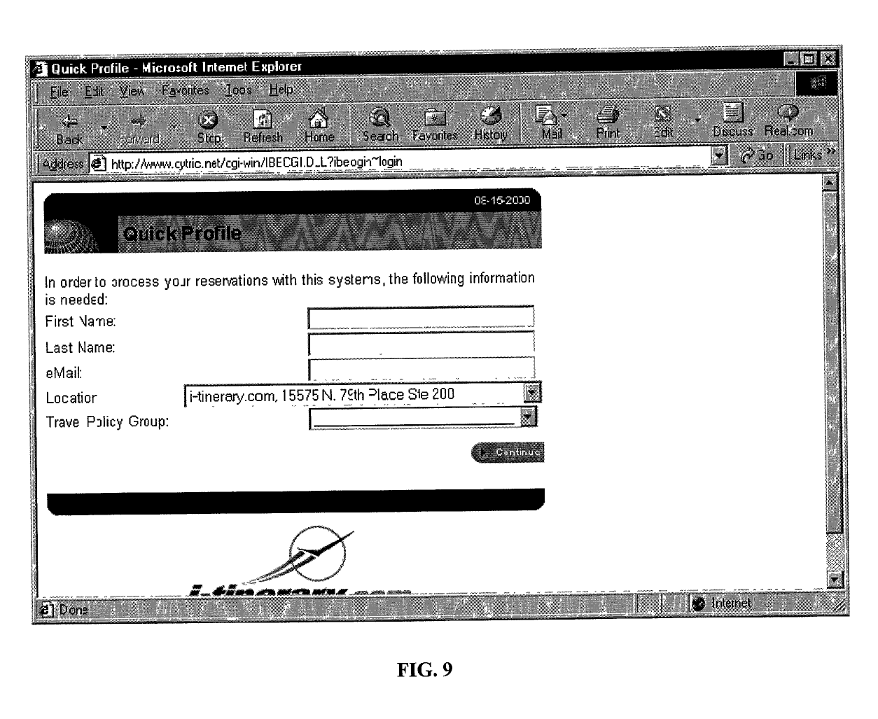

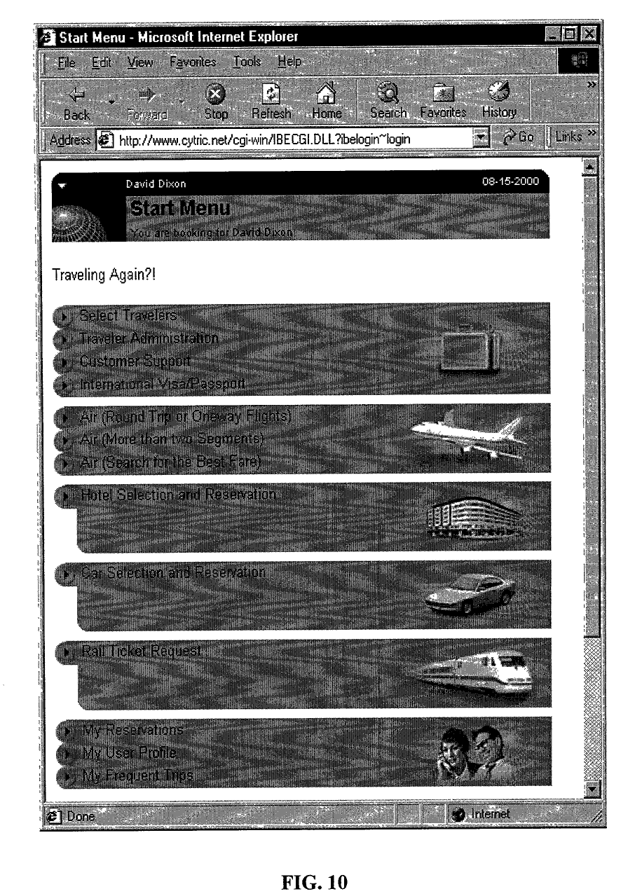

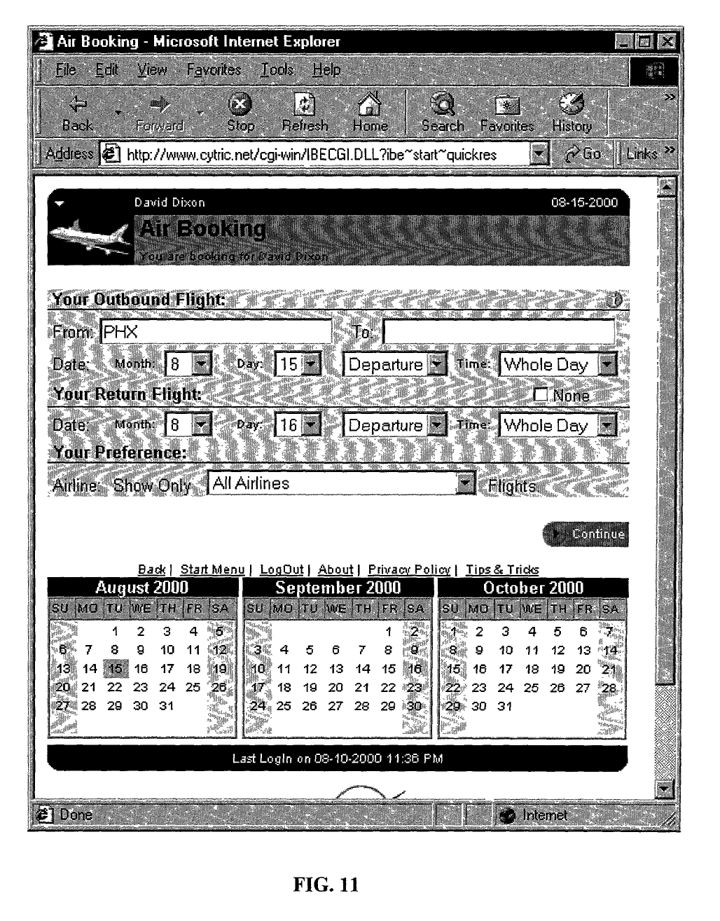

The file is then submitted to the booking engine (step 216). As the booking engine processes the file, it automatically is stepped through the login, profile, start, and booking processes that would be encountered by a user that accesses the host computer system to manually submit a travel request. In this case, however, the process is automatically performed using the previously supplied input including login, password and account information. As the booking engine is automatically stepped through the process, the Web pages associated with this process are displayed to the user via the booking engine browser. FIGS. 8 through 11 illustrate Web pages included in manual travel arrangement and booking process utilizing the presently preferred embodiment of the invention. FIG. 8 depicts a screen capture of the login page, FIG. 9 shows a screen capture of the profile page, FIG. 10 illustrates a screen capture of the start page, and FIG. 11 shows a screen capture of the air booking page.

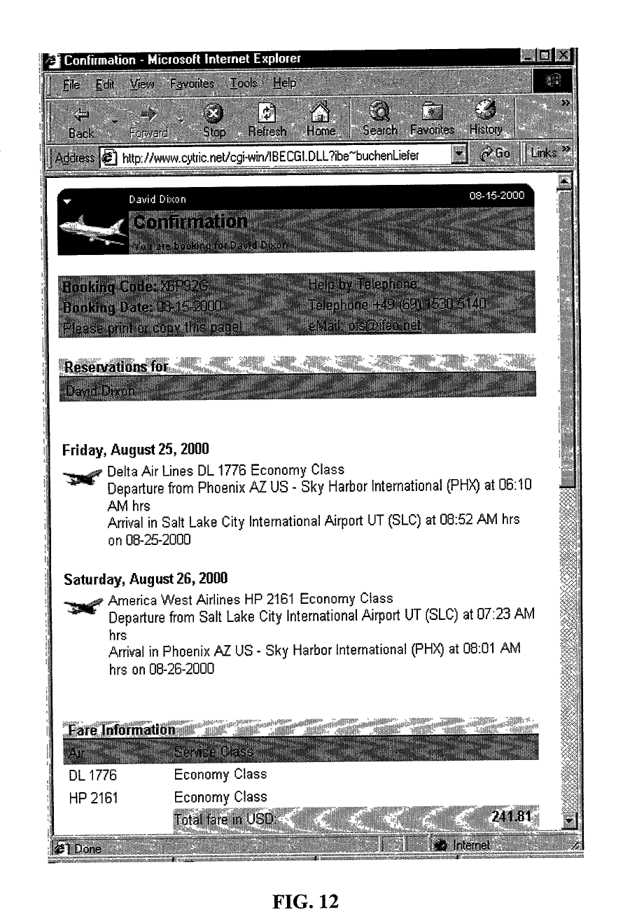

Referring again, to FIG. 5, the booking engine submits the travel request query to the GDS (step 218), the GDS retrieves the availability using the request parameters (step 220), and the GDS sends the availability to the booking engine (step 222). The booking engine receives the availability information and formats it into a file (step 224). This file contains the information include in a suggested itinerary for the traveler. The travel request processor 74 creates response page (step 226) and sends the response page to the booking engine browser (step 228). The response page displays to the user all air, car and hotel segments that were sold and all air, car and hotel segments that failed and were not resolved during the process. At this point, browser control is returned to the user (step 230) by the plug-in 88. The user reviews and edits the suggested itinerary (step 232). The user can interact with the booking engine 79 of the host site in the same manner in which a user can access the web site manually through signing on directly. The user can make changes to the suggested itinerary or process additional requests through the booking engine 79. During this process, the plug-in 88 monitors the browser activity (step 234). As long as the user is accessing the host site and has not terminated the session or confirmed an itinerary, the plug-in 88 idles. If the user terminates the session without confirming an itinerary, the plug-in 88 closes the browser (step 238) and the process is ended. Upon confirmation of an itinerary by the user, the confirmation page is displayed (step 236) in the browser. FIG. 12 represents a screen capture of a confirmation page displayed by the presently preferred embodiment of the invention. Referring again to FIG. 5, the itinerary data included in the confirmation is parsed into the itinerary object by the booking engine translator (step 240). The appointment object is created by the itinerary object (step 242) and includes the appointment events. The booking engine browser session is ended (step 238) and the plug-in adds or replaces appointment events in the calendar application (step 244).

### Business Rules

The travel request processor 74 formulates the query file 214 by applying a set of business rules to the data supplied by travel request object 114, the settings object 122, and the user profile data stored in the database 77. These business rules provide the systematic logic required to produce an efficient itinerary appropriate for the user.

### Air Booking Process

In general, all requests are executed in order by city pairs with air bookings executed first, followed by car bookings, and then hotel bookings. A city pair is defined by the origination city and the user's desired destination.

In the presently preferred embodiment of the invention, the personal preferences previously listed in Table 13 and included in the user profile information are used to generate a set of conditions called the Specific Matrix Generated Requirements (SMGR), which are used in the air booking process. The SMGR are determined by ranking the seven categories of preferences listed in Table 13 and using the two highest ranking categories to generate the SMGR. Each of the seven categories is rated on a scale from 1 to 5 by the user, with 5 being the highest rating. The two categories with the highest scale values are considered the primary and secondary categories, respectively. In the case of equal ratings, the hierarchy for ranking categories with equal ratings is:

1. Lowest Price

2. Arrival/Departure Time

3. Airline

4. Non-stop

5. Duration

6. Alternate Airports

7. Full Fare Auto Upgrades

Given that the primary category in the Specific Matrix Generated Requirements is Lowest Price and secondary category in the SMGR is Arrival/Departure Time, the following rules are enforced by the travel request processor 74:

Execute an availability request for each City pair using Preferred Airlines=All and any other defined qualifier values

Initiate an initial flight selection for the city pair

Price the selected flight(s) with Preferred Airline Class=the user's Personal Preferences value; Accept Penalties/Restrictions value=user's Personal Preferences value and any other defined qualifier values.

Select and sell the flight(s) where the price is lowest and the Arrival/Departure Time and Date is closest to the requested time and date.

It will be understood that the use of the terms “sell” and “sold” in the foregoing discussion and in the context of discussing the GDS means to reserve in inventory.

Given that the primary category in the Specific Matrix Generated Requirements is Arrival/Departure Time and secondary category in the SMGR is Low Price, the following rules are enforced by the travel request processor 74:

Execute an availability request for each city pair using Preferred Airlines=All and any other defined qualifier values.

Initiate an initial flight selection for the city pair.

Price the selected flight(s) with Preferred Airline Class=the user's Personal Preferences value; Accept Penalties/Restrictions value=user's Personal Preferences value and any other defined qualifier values:

Select and sell the lowest priced flight(s) within the Arrival/Departure Time and Date window defined by the Request Buffer Window. If the Arrive By was selected in initiating the travel request, evaluate the Arrive Before and Arrive After fields to determine the time range. If the Depart By was selected in initiating the travel request, evaluate the Depart Before and Depart After fields to determine the time range.

Given that the primary category in the Specific Matrix Generated Requirements is Low Price and secondary category in the SMGR is Duration, the following rules are enforced by the travel request processor:

Execute an availability request for each City pair with Preferred Airlines=All and any other defined qualifier values. Initiate an initial flight selection for the City pair.

Price the selected flight(s) with Preferred Airline Class=the user's Personal Preferences value; Accept Penalties/Restrictions value=user's Personal Preferences value and any other defined qualifier values Determine the duration of flights or group of flights returned for the City pair.

Determine the flight with the shortest duration and set as the baseline.

Determine the list of flights which have a variance in duration time of ±10% of the baseline.

Select and sell the flight(s) where the price is lowest within the list derived in the previous step.

With seven categories used to generate the Specific Matrix Generated Requirements, there are forty-two sets of SMGR, the three detailed above and thirty-nine others. The forty-two combinations are detailed in Appendix A, which includes the business rules associated with the application of the prioritization of user rated preferences in determining the query for air travel in the presently preferred embodiment of the invention.

Other qualifiers by which the travel request processor 74 formulates the query file for the booking engine are as follows:

When business requirements state to initiate a flight selection for the city pair, the flight selection may, by necessity, include one or more flights in order to complete travel between the city pair. Select the flight(s) closest to the requested Arrival/Departure Time which has a Preferred Airline Class the user's Personal Preferences value.

When business requirements indicate that a pricing request is to be made unless indicated otherwise: the Accept Penalties/Restrictions value will be included in the pricing and:

In the case where a value is present in the Fare Savings Minimum field and the Accept Penalties/Restrictions=Yes, two pricing requests will be made where: 1) the Accept Penalties/Restrictions Yes and 2) the Accept Penalties/Restrictions=No. The pricing data will be saved for comparison in the select and sell process.

In the case where no value is present in the Fare Savings Minimum field, a single pricing request will be made where the Accept Penalties/Restrictions=the user's Personal Preferences value.

When business requirements indicate that a selection and sell request is to be made:

In the case where two pricing requests were executed in pricing and Lowest Fare is to be considered in the selection process, compare the lowest fare for each of the requests. The Accept Penalties/Restrictions=Yes fare will be selected only when the savings of the AP/R=Yes fare over the AP/R=No fare meets or exceeds the flat dollar amount savings indicated in the Fare Savings Minimum Field.

In the case where Alternate Airports will be considered in the Low Price selection process;

If there are no values in the Fare Savings Minimum field, an Alternate Airport fare will be selected when the SMGR indicates that the Alternate Airport fare is to be selected and sold.

If there are any values in the Fare Savings Minimum field, an Alternate Airport fare will be selected only when the savings over the originally priced fare meets or exceeds the flat dollar amount savings indicated in the Fare Savings Minimum Field.

During the selection and sell process, after all other business requirements have been executed for the defined conditions of each rule set, the possibility of more than one valid choice may still exist. In that event, the priority to determine selection of the flight itinerary item(s) is lowest price first, then time. If application of this lowest price rule still results in multiple valid choices, then the first valid choice that meets all other defined and applicable rules will be selected and sold for use in the itinerary that is automatically created.

After the selection process, evaluate the Class Pricing Option.

In the case where the Class Pricing Option=No, no extra action is required.

In the case where the Class Pricing Option=Yes, the following business rules apply:

If the Class of Service for the selected fare is first class or business and the Fare Savings Minimum contains a value, perform an itinerary fare quote.

If there is a lower coach fare than the first class or business fare where the same Accept Penalties/Restrictions qualifier value applies to the coach fare as applied to the original fare, calculate the savings on the lowest fare where Fare Savings Minimum=Business or First Class Fare—Coach Fare

Select the coach fare if the calculated savings is equal to or greater than the value indicated in the Fare Savings Minimum field.

Retain the first or business class fare if the calculated savings is less than the value indicated in the Fare Savings Minimum field.

If there is not a lower coach fare than the first class or business fare, retain the first class or business fare.

If the Class of Service for the selected fare is coach and the Fare Increase Maximum contains a value, perform an itinerary fare quote.

If there is a higher business or first class fare with the same Accept Penalties/Restriction value as the coach, calculate the fare increase amount on the lowest priced increased fare as Fare Increase Maximum=Business or First Class Fare—Coach Fare

If there is a higher business or first class fare with the same Accept Penalties/Restriction value as the coach fare and if the calculated fare increase from the lowest applicable business or first class fare is greater than the value indicated in the Fare Increase Maximum field, retain the coach fare.

If there is a higher business or first class fare with the same Accept Penalties/Restriction value as the coach fare and if the calculated fare increase from the lowest applicable business or first class fare is less than the value indicated in the Fare Increase Maximum field, select the first class or business fare.

If there is not a lower coach fare with the same Accept Penalties/Restriction value as the first class or business fare, retain the first class or business fare.

The aforementioned business rules and in the Specific Matrix Generated Requirements are applied to every city pair in the air booking process until flights have been sold for all city pairs. When flights have been sold for all city pairs, an air compatibility request is executed to verify that there are no conflicting flights. If flights conflict, the air booking business rules are started at the first city pair that failed and are executed for each city pair that failed, until flights for all city pairs have been selected and saved. If no flights conflict or when all conflicting flights have been resolved, the air booking process is initiated.

### Car Booking

After the completion of the air booking, process, the travel request processor 74 performs the car booking process. Six car types are considered. Table 15 shows a hierarchy of car type pairs with a primary and secondary car type for each pair.

TABLE 15

| Car Type Pair | Primary Car Type | Secondary Car Type |
|---|---|---|
| 1 | Economy | Compact |
| 2 | Compact | Intermediate |
| 3 | Intermediate | Full |
| 4 | Full | Premium |
| 5 | Premium | Luxury |

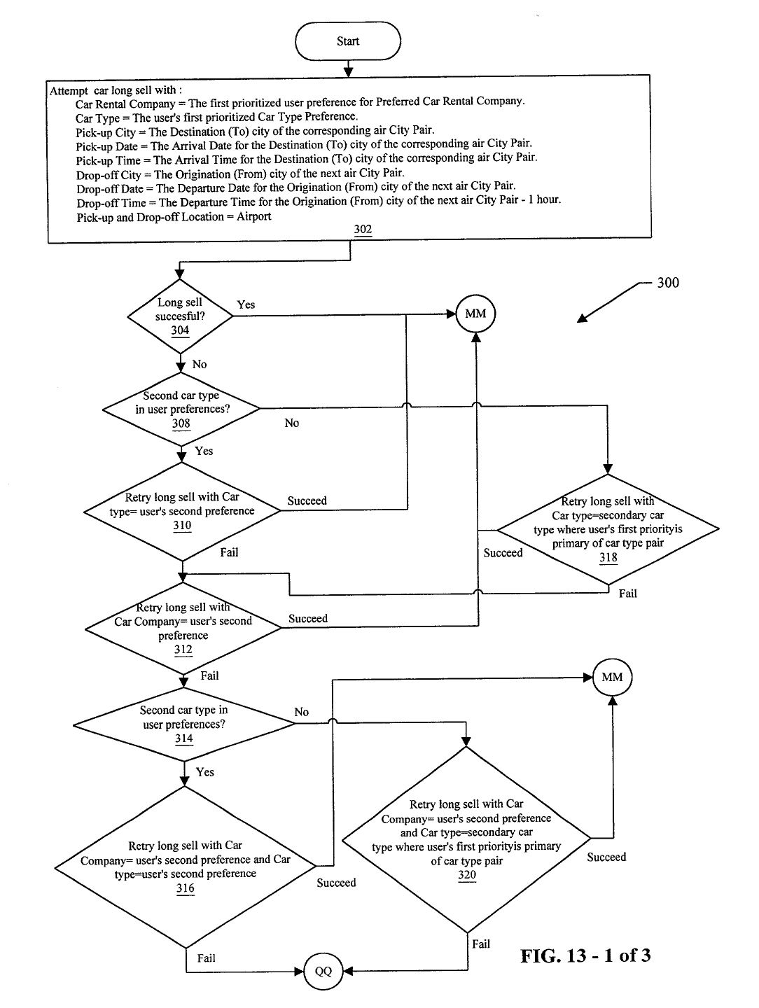

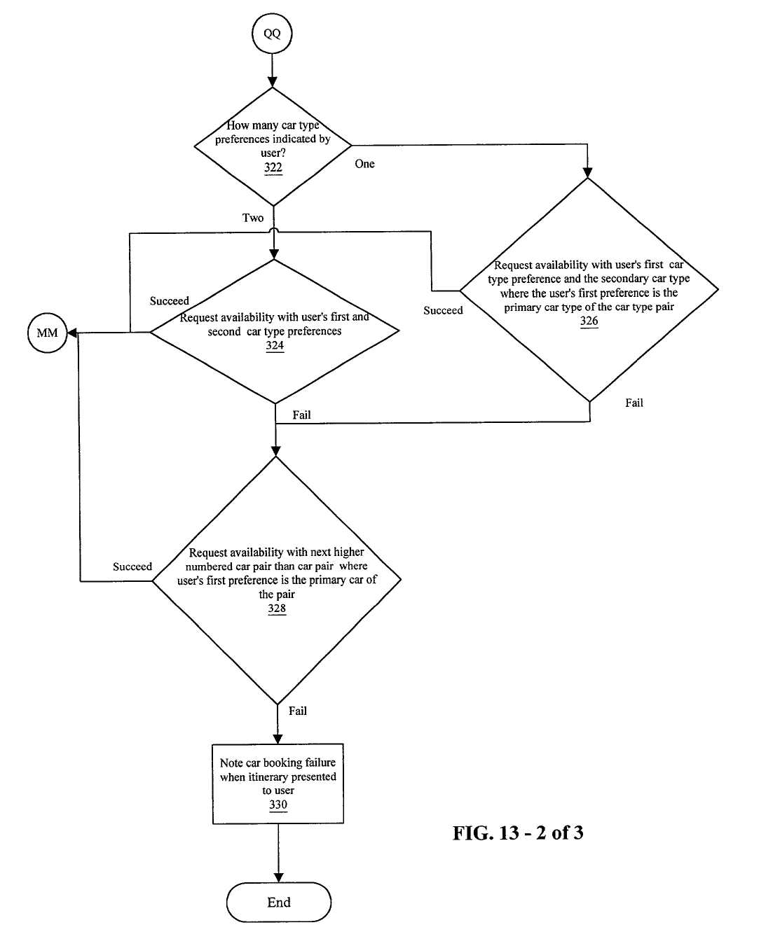

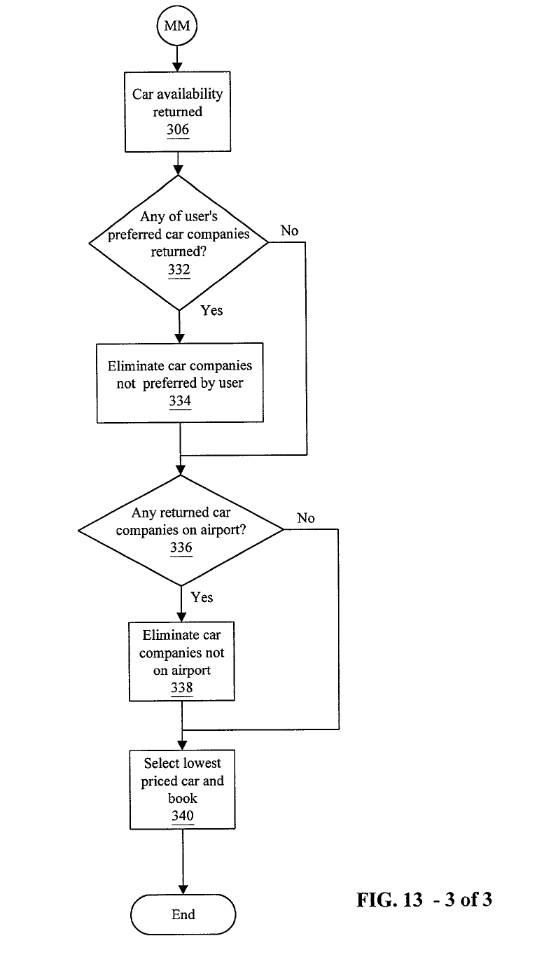

This hierarchy is used in the car booking method 300 depicted in FIG. 13, which is the presently preferred car booking method in accordance with the invention. Variables are set for the initial long sell attempt (step 302). They are:

Car Rental Company=The first prioritized user preference for Preferred Car Rental Company.

Car Type=The user's first prioritized Car Type Preference.

Pick-up City=The Destination (To) city of the corresponding air City Pair.

Pick-up Date=The Arrival Date for the Destination (To) city of the corresponding air City Pair.

Pick-up Time=The Arrival Time for the Destination (To) city of the corresponding air City Pair.

Drop-off City=The Origination (From) city of the next air City Pair.

Drop-off Date=The Departure Date for the Origination (From) city of the next air City Pair.

Drop-off Time=The Departure Time for the Origination (From) city of the next air City Pair—1 hour.

Pick-up and Drop-off Location=Airport A long sell is a request that attempts to sell a car without first going through an availability request.

If the long sell is successful, the availability is returned (step 306). If the long sell is not successful, a determination is made if a second car type exists in the user preferences (step 308). If a second car type exists, then a long sell is retried with car type set to the user's second preference (step 310). If not, then the long sell is retried (step 318) with the car type set to the secondary car type of Table 15 where user's first priority is the primary of car type pair. If the long sell attempt with the car type set to the user's second preference (step 310) fails, then it is retried with the car company set to the user's second preference (step 312). If no second preference exists, then the long sell is retried (step 320) with the car type set to the secondary car type of Table where the user's first priority is the primary car type of the car type pair. If a second preference exists, then the long sell is attempted with the car company set to the user's second preference (step 316). If successful, an availability is returned (step 306). If not successful, then a check to see how many car type preferences have been indicated by the user is made (step 322). If one, then an availability request with the user's first car type preference and the secondary car type where the user's first preference is the primary car type of the car type pair is made (step 326). If two, then an availability request is made with the user's first and second car type preferences (step 324). If either of the two requests (step 324 or 326) is successful, a car availability is returned (step 306). If both of the two request (step 324) and (step 326) fail, then an availability is requested (step 328) with the next higher numbered car type pair of Table 15 than the car type pair where user's first preference is the primary car of the pair. If this request (step 328) is successful, an availability is returned (step 306). If it is not, the a message is prepared (step 330) for delivery when the itinerary is presented indicating to a car booking failure.

Once an availability is returned (step 306), a check is made (step 332) to see if any of the user's preferred car companies is included in the availability. If no user preferred car companies are included in the returned availability, then a check is made to see if any of the returned companies is on the airport (step 336). If any user preferred car companies are included in the returned availability, then those car companies in the return that are not included in the user's preferences are eliminated (step 334) and a check is made to see if any of the returned companies is on the airport (step 336). If none are on the airport, then the lowest priced car is selected and booked (step 340). If any returned cars are on the airport, then the car companies not on the airport are eliminated (step 338) and then the lowest priced car is selected and booked (step 340).

### Hotel Booking

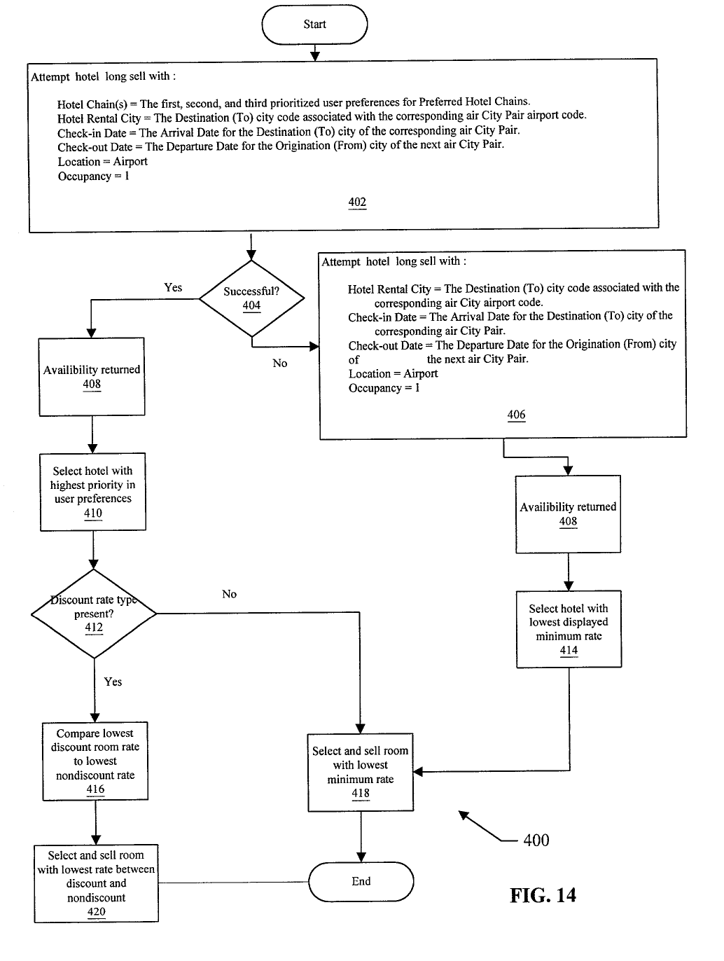

Upon completion of the car booking method 300, the hotel booking method 400 is initiated. FIG. 14 depicts the presently preferred hotel booking method 400 in accordance with the invention. A first hotel long sell attempt (step 402) is made with:

Hotel Chain(s)=The first, second, and third prioritized user preferences for Preferred Hotel Chains.

Hotel Rental City=The Destination city code associated with the corresponding air city pair airport code.

Check-in Date=The Arrival Date for the Destination city of the corresponding air city pair.

Check-out Date=The Departure Date for the Origination city of the next air city pair.

Location=Airport

Occupancy=1

If this long sell (step 402) is successful, availability is returned (step 408) and the hotel with the highest priority of the user's preferences is selected (step 410). If the long sell (step 402) is not successful, then another long sell (step 406) is attempted with:

Hotel Rental City=The Destination city code associated with the corresponding air city airport code.

Check-in Date=The Arrival Date for the Destination city of the corresponding air city pair.

Check-out Date=The Departure Date for the Origination (From) city of the next air city pair.

Location=Airport

Occupancy=1

and availability is returned (step 408). The hotel with the lowest displayed minimum rate is then selected (step 414) and the room with the lowest minimum rate is selected and sold (step 418).

Referring again to the selection of the hotel with highest priority in the user preferences (step 410), the selection is searched to see if the user has a discount rate with that hotel (step 412). If no discount rate exists with the selected hotel, then the room with the lowest minimum rate is selected and sold (step 418). If a discount rate exists, then the lowest discount room rate and the lowest non-discount room rate are compared (step 416), and the room with the lowest rate between the discount rate and non-discount rate is selected and sold (step 420).

### Calendaring Appointment Events

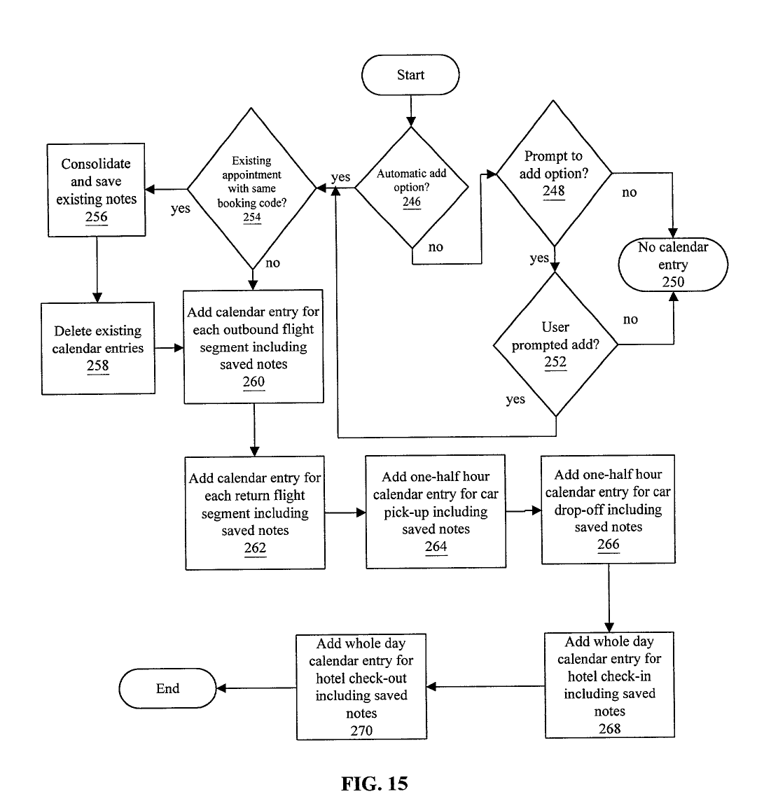

FIG. 15 illustrates the method by which the plug-in 88 adds or replaces appointments in the calendar application 86 resulting from the confirmed itinerary. The Automatic Add option in the settings object 122 is monitored (step 246) and if Prompt to Add was selected (step 248), the user is prompted (step 252) and no calendar is made (step 250) if the prompted response is “No.” If the user responds affirmatively, then the plug-in 88 looks to see if an appointment already exists with the same booking ID. If such an entry exists, then the plug-in consolidates the old notes with the new notes (step 256), saves the notes, and deletes the existing calendar entries (step 258). Then the plug-in adds a calendar entry for each outbound flight segment including saved notes (step 260), adds a calendar entry for each return flight segment including saved notes (step 262), adds a one-half hour calendar entry for car pick-up including saved notes (step 264), adds a one-half hour calendar entry for car drop-off including saved notes (step 266), adds a whole day calendar entry for hotel check-in including saved notes (step 268), and adds a whole day calendar entry for hotel check-out including saved notes.

It will be apparent to one of ordinary skill in the art that the invention can be implemented using a variety of other sophisticated business rules in a wide variety of combinations. As described herein, the exemplary set of logical rules is for descriptive purposes only and the concepts equally apply to other business rule implementations, including those methods having rule sets dissimilar to those described herein.

### Conclusion

The above-described method and system of the present invention possess numerous advantages. The invention can generate a travel request from within a calendar application using information obtained from the calendar application. It can be used to submit the travel request to an intelligent travel request processor that systematically applies a set of business rules using previously supplied user information, including traveler-rated personal preferences, to generate a set of complex queries for presentation to a the travel industry's travel distribution system. The invention can automatically generate a set of suggested itinerary items for review by the user with no user interaction subsequent to travel request submittal. The invention can automatically generate appointment events from a confirmed itinerary and add them to the user's calendar. The invention can dramatically reduce the expenditure of time and resources needed to plan and calendar business travel.

Additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept as defined by the appended claims and their equivalents.

### APPENDIX A

Specific Matrix Generated Requirements (SMGR) Business Rules

1. Given Low Price=Primary and Arrival/Departure Time=Secondary

1.1 Execute an availability request for each City Pair using the following variable qualifier values and the previously defined qualifier values: Preferred Airlines=All;

1.2 Initiate an initial flight selection for the City Pair.

1.3 Price the selected flight(s) with the following variable qualifier values and the previously defined qualifier values: Preferred Airline Class=the user's Personal Preferences value; Accept Penalties/Restrictions value=user's Personal Preferences value.

1.4 Select and sell the flight(s) where the price is lowest and the Arrival/Departure Time (Date) is closest to the requested time and date.

2. Given Arrival/Departure Time=Primary and Low Price=Secondary

2.1 Execute an availability request for each City Pair using the following variable qualifier values and the previously defined qualifier values: Preferred Airlines=All;

2.2 Initiate an initial flight selection for the City Pair.

2.3 Price the selected flight(s) with the following variable qualifier values and the previously defined qualifier values: Preferred Airline Class=the user's Personal Preferences value; Accept Penalties/Restrictions value=user's Personal Preferences value.

2.4 Select and sell the lowest priced flight(s) within the Arrival/Departure Time (Date) window defined by the Request Buffer Window. If the Arrive By was selected in the initiating travel request, evaluate the Arrive Before and Arrive After fields to determine the time range. If the Depart By was selected in the initiating travel request, evaluate the Depart Before and Depart After fields to determine the time range.

3. Given Low Price=Primary and Duration=Secondary

3.1 Execute an availability request for each City Pair using the following variable qualifier values and the previously defined qualifier values: Preferred Airlines=All;

3.2 Initiate an initial flight selection for the City Pair.

3.3 Price the selected flight(s) with the following variable qualifier values and the previously defined qualifier values: Preferred Airline Class=the user's Personal Preferences value; Accept Penalties/Restrictions value=user's Personal Preferences value.

3.4 Determine the duration of flights or group of flights returned for the City Pair.

3.5 Determine the flight with the shortest duration (baseline).

3.6 Determine the list of flights which have a variance in duration time of ±10% of the baseline (derived variance list).

3.7 Select and sell the flight(s) where the price is lowest within the derived variance list.

4. Given Duration=Primary and Low Price=Secondary

4.1 Execute an availability request for each City Pair using the following variable qualifier values and the previously defined qualifier values: Preferred Airlines=All;

4.2 Initiate an initial flight selection for the City Pair.

4.3 Price the selected flight(s) with the following variable qualifier values and the previously defined qualifier values: Preferred Airline Class=the user's Personal Preferences value; Accept Penalties/Restrictions value=user's Personal Preferences value.

4.4 Determine the duration of flights or group of flights returned for the City Pair.

4.5 Determine the flight with the shortest duration (baseline).

4.6 Determine the list of flights which have a variance in duration time of ±10% of the baseline.

4.7 Select and sell the flight(s) where the price is lowest within the derived variance list.

5. Given Low Price=Primary and Non-Stop=Secondary

5.1 Execute an availability request for each City Pair using the following variable qualifier values and the previously defined qualifier values: Preferred Airlines=All;

5.2 Initiate an initial flight selection for the City Pair.

5.3 Price the selected flight(s) with the following variable qualifier values and the previously defined qualifier values: Preferred Airline Class=the user's Personal Preferences value; Accept Penalties/Restrictions value=user's Personal Preferences value.

5.4 Select and sell the lowest price fare closest to the Arrival/Departure Time, within the calculated Buffer Window.

6. Given Non-Stop=Primary and Low Price=Secondary

6.1 Execute an availability request for each City Pair using the following variable qualifier values and the previously defined qualifier values: Preferred Airlines=All;

6.2 Initiate an initial flight selection for the City Pair.

6.3 Price the selected flight(s) with the following variable qualifier values and the previously defined qualifier values: Preferred Airline Class=the user's Personal Preferences value; Accept Penalties/Restrictions value=user's Personal Preferences value.

6.4 Select and sell the Non-stop flight with the lowest fare.

6.5 If a Non-stop flight is not available, select and sell the Direct flight with the lowest fare.

6.6 If a Direct flight is not available, select and sell the Online Connection flight with the lowest fare.

6.7 If an Online Connection flight is not available, select and sell the Interline Connection flight with the lowest fare.

6.8 If an Interline Connection flight is not available, select and sell the Multi-online Connection flight with the lowest fare.

6.9 If a Multi-online Connection flight is not available, select and sell the Multi-interline Connection flight with the lowest fare.

7. Given Low Price=Primary and Alternate Airport=Secondary

7.1 Execute an availability request for each City Pair using the following variable qualifier values and the previously defined qualifier values: Preferred Airlines=All; Alternate Airports=Y, regardless of Personal Preferences setting.

7.2 Initiate an initial flight selection for the City Pair.

7.3 Price the selected flight(s) with the following variable qualifier values and the previously defined qualifier values: Preferred Airline Class=the user's Personal Preferences value; Accept Penalties/Restrictions value=user's Personal Preferences value.

7.4 Select and sell the lowest price fare closest to the Arrival/Departure Time, regardless of airport.

8. Given Alternate Airport=Primary and Low Price=Secondary

8.1 Execute an availability request for each City Pair using the following variable qualifier values and the previously defined qualifier values: Preferred Airlines=All; Alternate Airports=Y, regardless of Personal Preferences setting.

8.2 Initiate an initial flight selection for the City Pair.

8.3 Price the selected flight(s) with the following variable qualifier values and the previously defined qualifier values: Preferred Airline Class=the user's Personal Preferences value; Accept Penalties/Restrictions value=user's Personal Preferences value.

8.4 Select and sell the lowest price fare closest to the Arrival/Departure Time, regardless of airport.

9. Given Low Price=Primary and Full Fare Auto Upgrades=Secondary

9.1 Execute an availability request for each City Pair using the following variable qualifier values and the previously defined qualifier values: Preferred Airlines=All;

9.2 Initiate an initial flight selection for the City Pair.

9.3 Price the selected flight(s) with the following variable qualifier values and the previously defined qualifier values: Preferred Airline Class=the user's Personal Preferences value; Accept Penalties/Restrictions value=user's Personal Preferences value.

9.4 If the user's Personal Preferences Accept Penalties/Restrictions value is ‘Y,’ select and sell the lowest fare.

9.5 If the Accept Penalties/Restrictions value is ‘N,’ and there is an Auto Upgrade Fare, select and sell the lowest price Upgrade fare.

9.6 If the Accept Penalties/Restrictions value is ‘N,’ and there are no Auto Upgrade Fares, select and sell the lowest price fare.

10. Given Full Fare Auto Upgrades=Primary and Low Price=Secondary

10.1 Execute an availability request for each City Pair using the following variable qualifier values and the previously defined qualifier values: Preferred Airlines=All;

10.2 Initiate an initial flight selection for the City Pair.

10.3 Price the selected flight(s) with the following variable qualifier values and the previously defined qualifier values: Preferred Airline Class=the user's Personal Preferences value; The Accept Penalties/Restrictions value=‘N,’ regardless of the user's Personal Preferences.

10.4 If an Upgrade fare is returned in the pricing, select and sell the lowest priced Upgrade fare.

10.5 If an Upgrade fare is not returned in pricing and If the Accept Penalties/Restrictions value is ‘N’ in the user's Personal Preferences, select and sell the lowest fare.

10.6 If an Upgrade fare is not returned in pricing and If the Accept Penalties/Restrictions value is ‘Y’ in the user's Personal Preferences, re-price the original itinerary with penalties and restrictions, then select and sell the lowest fare.

11. Given Low Price=Primary and Preferred Airlines=Secondary

11.1 Execute an availability request for each City Pair using the following variable qualifier values and the previously defined qualifier values: Preferred Airlines=All;

11.2 Initiate an initial flight selection for the City Pair.

11.3 Price the selected flight(s) with the following variable qualifier values and the previously defined qualifier values: Preferred Airline Class=the user's Personal Preferences value; The Accept Penalties/Restrictions value=user's Personal Preferences.

11.4 Select and sell the lowest fare available.

11.5 If more than one fare can be selected, select and sell the fare for the airline(s) indicated in the user's Preferred Airlines, selected by priority.

11.6 If there are no fares for Preferred Airlines, select and sell the lowest priced fare.

12. Given Preferred Airlines=Primary and Low Price=Secondary

12.1 Execute an availability request for each City Pair using the following variable qualifier values and the previously defined qualifier values: Preferred Airlines=up to the first three prioritized airlines in User Profile—Personal Preferences;

12.2 Initiate an initial flight selection for the City Pair.

12.3 Price the selected flight(s) with the following variable qualifier values and the previously defined qualifier values: Preferred Airline Class=the user's Personal Preferences value; The Accept Penalties/Restrictions value=user's Personal Preferences.

12.4 Select and sell the lowest fare available, by Preferred Airline priority.

13. Given Arrival/Departure Time=Primary and Duration=Secondary

13.1 Execute an availability request for each City Pair using the following variable qualifier values and the previously defined qualifier values: Preferred Airlines=All;

13.2 Initiate an initial flight selection for the City Pair.

13.3 Price the selected flight(s) with the following variable qualifier values and the previously defined qualifier values: Preferred Airline Class=the user's Personal Preferences value; The Accept Penalties/Restrictions value=the user's Personal Preferences value.

13.4 Evaluate all the returned flights which are within the Arrival/Departure range defined by the Request Buffer Window.

13.5 Determine the duration of flights or group of flights within the Request Buffer Window.

13.6 Determine the flight with the shortest duration and sell the flight.

14. Given Duration=Primary and Arrival/Departure Time=Secondary

14.1 Execute an availability request for each City Pair using the following variable qualifier values and the previously defined qualifier values: Preferred Airlines=All;

14.2 Initiate an initial flight selection for the City Pair.

14.3 Price the selected flight(s) with the following variable qualifier values and the previously defined qualifier values: Preferred Airline Class=the user's Personal Preferences value; The Accept Penalties/Restrictions value=the user's Personal Preferences value.

14.4 Determine the duration of flights or group of flights returned for the City Pair.

14.5 Determine the flight with the shortest duration (baseline).

14.6 Determine the list of flights which have a variance in duration time of ±10% of the baseline.

14.7 Select and sell the flight(s) where the Arrival/Departure Time is closest to the requested Arrival/Departure Time.

15. Given Arrival/Departure Time=Primary and Non-Stop=Secondary

15.1 Execute an availability request for each City Pair using the following variable qualifier values and the previously defined qualifier values: Preferred Airlines=All;

15.2 Initiate an initial flight selection for the City Pair.

15.3 Price the selected flight(s) with the following variable qualifier values and the previously defined qualifier values: Preferred Airline Class=the user's Personal Preferences value; The Accept Penalties/Restrictions value=the user's Personal Preferences value.

15.4 Evaluate all the returned flights which are within the Arrival/Departure range defined by the Request Buffer Window.

15.5 Select and sell the Non-stop flight closest to the requested Arrival/Departure Time.

15.6 If a Non-stop flight is not available, select and sell the Direct flight closest to the requested Arrival/Departure Time.

15.7 If a Direct flight is not available, select and sell the Online Connection flight closest to the requested Arrival/Departure Time.

15.8 If an Online Connection flight is not available, select and sell the Interline Connection flight closest to the requested Arrival/Departure Time.

15.9 If an Interline Connection flight is not available, select and sell the Multi-online Connection flight closest to the requested Arrival/Departure Time.

15.10 If a Multi-online Connection flight is not available, select and sell the Multi-interline Connection flight closest to the requested Arrival/Departure Time.

16. Given Non-Stop=Primary and Arrival/Departure Time=Secondary

16.1 Execute an availability request for each City Pair using the following variable qualifier values and the previously defined qualifier values: Preferred Airlines=All;

16.2 Initiate an initial flight selection for the City Pair.

16.3 Price the selected flight(s) with the following variable qualifier values and the previously defined qualifier values: Preferred Airline Class=the user's Personal Preferences value; The Accept Penalties/Restrictions value=the user's Personal Preferences value.

16.4 Select and sell the Non-stop flight closest to the requested Arrival/Departure Time.

16.5 If a Non-stop flight is not available, select and sell the Direct flight closest to the requested Arrival/Departure Time.

16.6 If a Direct flight is not available, select and sell the Online Connection flight closest to the requested Arrival/Departure Time.

16.7 If an Online Connection flight is not available, select and sell the Interline Connection flight closest to the requested Arrival/Departure Time.

16.8 If an Interline Connection flight is not available, select and sell the Multi-online Connection flight closest to the requested Arrival/Departure Time.

16.9 If a Multi-online Connection flight is not available, select and sell the Multi-interline Connection flight closest to the requested Arrival/Departure Time.

17. Given Arrival/Departure Time=Primary and Alternate Airport=Secondary

17.1 Execute an availability request for each City Pair using the following variable qualifier values and the previously defined qualifier values: Preferred Airlines=All; Alternate Airports Y, regardless of Personal Preferences setting.

17.2 Initiate an initial flight selection for the City Pair.

17.3 Price the selected flight(s) with the following variable qualifier values and the previously defined qualifier values: Preferred Airline Class=the user's Personal Preferences value; Accept Penalties/Restrictions value=user's Personal Preferences value.

17.4 Select and sell the flight(s) closest to the Arrival/Departure Time, regardless of airport.

18. Given Alternate Airport=Primary and Arrival/Departure Time=Secondary

18.1 Execute an availability request for each City Pair using the following variable qualifier values and the previously defined qualifier values: Preferred Airlines=All; Alternate Airports=Y, regardless of Personal Preferences setting.

18.2 Initiate an initial flight selection for the City Pair.

18.3 Price the selected flight(s) with the following variable qualifier values and the previously defined qualifier values: Preferred Airline Class=the user's Personal Preferences value; Accept Penalties/Restrictions value=user's Personal Preferences value.

18.4 Select the flight(s) closest to the Arrival/Departure Time, regardless of airport.

19. Given Arrival/Departure Time=Primary and Full Fare Auto Upgrades=Secondary

19.1 Execute an availability request for each City Pair using the following variable qualifier values and the previously defined qualifier values: Preferred Airlines=All;

19.2 Initiate an initial flight selection for the City Pair.

19.3 Price the selected flight(s) with the following variable qualifier values and the previously defined qualifier values: Preferred Airline Class=the user's Personal Preferences value; Accept Penalties/Restrictions value=user's Personal Preferences value.

19.4 If the Accept Penalties/Restrictions value is ‘Y,’ select and sell the flight closest to the requested Arrival/Departure Time.

19.5 If the Accept Penalties/Restrictions value is ‘N,’ and there is an Auto Upgrade Fare, select and sell the Upgrade fare closest to the requested Arrival/Departure Time.

19.6 If the Accept Penalties/Restrictions value is ‘N,’ and there are no Auto Upgrade Fares, select and sell the closest to the requested Arrival/Departure Time.

20. Given Full Fare Auto Upgrades=Primary and Arrival/Departure Time=Secondary

20.1 Execute an availability request for each City Pair using the following variable qualifier values and the previously defined qualifier values: Preferred Airlines=All;

20.2 Initiate an initial flight selection for the City Pair.

20.3 Price the selected flight(s) with the following variable qualifier values and the previously defined qualifier values: Preferred Airline Class=the user's Personal Preferences value; The user's Accept Penalties/Restrictions value will be overridden to ‘N.’

20.4 If an Upgrade fare is returned in the pricing, select and sell the Upgrade fare closest to the requested Arrival/Departure Time.

20.5 If an Upgrade fare is not returned in pricing and If the original Accept Penalties/Restrictions value is ‘N’ in the user's Personal Preferences, select and sell the flight closest to the requested Arrival/Departure Time.

20.6 If an Upgrade fare is not returned in pricing and If the Accept Penalties/Restrictions value is ‘Y’ in the user's Personal Preferences, re-price the original itinerary with penalties and restrictions, then select and sell the flight closest to the requested Arrival/Departure Time.

21. Given Arrival/Departure Time=Primary and Preferred Airlines=Secondary

21.1 Execute an availability request for each City Pair using the following variable qualifier values and the previously defined qualifier values: Preferred Airlines=All;

21.2 Initiate an initial flight selection for the City Pair.

21.3 Price the selected flight(s) with the following variable qualifier values and the previously defined qualifier values: Preferred Airline Class=the user's Personal Preferences value; The Accept Penalties/Restrictions value=user's Personal Preferences.

21.4 Select and sell the flight(s) closest to the requested Arrival/Departure Time.

21.5 If more than one flight(s) meets the time requirement above, select and sell the flight(s) for the highest prioritized airline indicated in the user's Preferred Airlines list.

21.6 If more than one flight(s) meets the time requirement above and If there are no flight(s) for Preferred Airlines, select and sell the lowest priced flight(s).

22. Given Preferred Airlines=Primary and Arrival/Departure Time=Secondary

22.1 Execute an availability request for each City Pair using the following variable qualifier values and the previously defined qualifier values: Preferred Airlines=up to the first three prioritized airlines in User Profile—Personal Preferences;

22.2 Initiate an initial flight selection for the City Pair.

22.3 Price the selected flight(s) with the following variable qualifier values and the previously defined qualifier values: Preferred Airline Class=the user's Personal Preferences value; The Accept Penalties/Restrictions value=user's Personal Preferences.

22.4 Select and sell the flight(s) closest to the requested Arrival/Departure Time for the first prioritized Preferred Airline in the user's Personal Preferences.

22.5 If no flights are available for prioritized Preferred Airlines, select and sell the flight(s) closest to the requested Arrival/Departure Time.

23. Given Duration=Primary and Non-Stop=Secondary

23.1 Execute an availability request for each City Pair using the following variable qualifier values and the previously defined qualifier values: Preferred Airlines=All;

23.2 Initiate an initial flight selection for the City Pair.

23.3 Price the selected flight(s) with the following variable qualifier values and the previously defined qualifier values: Preferred Airline Class=the user's Personal Preferences value; Accept Penalties/Restrictions value=user's Personal Preferences value.

23.4 Determine the duration of flights or group of flights returned for the City Pair.

23.5 Determine the flight with the shortest duration (baseline).

23.6 Determine the list of flights which have a variance in duration time of ±10% of the baseline.

23.7 Select and sell the lowest priced Non-stop flight in the variance list.

23.8 If a Non-stop flight is not available, select and sell the lowest priced Direct flight in the variance list.

23.9 If a Direct flight is not available, select and sell the lowest priced Online Connection flight in the variance list.

23.10 If an Online Connection flight is not available, select and sell the lowest priced Interline Connection flight in the variance list.

23.11 If an Interline Connection flight is not available, select and sell the lowest priced Multi-online Connection flight in the variance list.

23.12 If a Multi-online Connection flight is not available, select and sell the lowest priced Multi-interline Connection flight in the variance list.

24. Given Non-Stop=Primary and Duration=Secondary

24.1 Execute an availability request for each City Pair using the following variable qualifier values and the previously defined qualifier values: Preferred Airlines=All;

24.2 Select the flight(s) in the variance list which has a Preferred Airline Class=the user's Personal Preferences value.

24.3 Price the selected flight(s) with the following variable qualifier values and the previously defined qualifier values: Preferred Airline Class=the user's Personal Preferences value; Accept Penalties/Restrictions value=user's Personal Preferences value.

24.4 Apply the duration calculation rules defined above to all the Non-stop flights returned from pricing, then select and sell the flight with the shortest duration.

24.5 If a Non-stop flight is not available, apply the duration calculation rules defined above to all the Direct flights returned from pricing, then select and sell the flight with the shortest duration.

24.6 If a Direct flight is not available, apply the duration calculation rules defined above to all the Online Connection flights returned from pricing, then select and sell the flight with the shortest duration.

24.7 If an Online Connection flight is not available, apply the duration calculation rules defined above to all the Interline Connection flights returned from pricing, then select and sell the flight with the shortest duration.

24.8 If an Interline Connection flight is not available, apply the duration calculation rules defined above to all the Multi-online Connection flights returned from pricing, then select and sell the flight with the shortest duration.

24.9 If a Multi-online Connection flight is not available, apply the duration calculation rules defined above to all the Multi-interline Connection flights returned from pricing, then select and sell the flight with the shortest duration.

24.10

25. Given Duration Primary and Alternate Airport=Secondary

25.1 Execute an availability request for each City Pair using the following variable qualifier values and the previously defined qualifier values: Preferred Airlines=All; Alternate Airports=Y, regardless of Personal Preferences setting.

25.2 Initiate an initial flight selection for the City Pair.

25.3 Price the selected flight(s) with the following variable qualifier values and the previously defined qualifier values: Preferred Airline Class=the user's Personal Preferences value; the Accept Penalties/Restrictions value=user's Personal Preferences value.

25.4 Determine the duration of flights or group of flights returned for the City Pair.

25.5 Determine the flight with the shortest duration (baseline).

25.6 Determine the list of flights which have a variance in duration time of ±10% of the baseline.

25.7 Select and sell the flight(s) with the shortest duration, regardless of airport.

26. Given Alternate Airport=Primary and Duration=Secondary

26.1 Execute an availability request for each City Pair using the following variable qualifier values and the previously defined qualifier values: Preferred Airlines=All; Alternate Airports=Y, regardless of Personal Preferences setting.

26.2 Initiate an initial flight selection for the City Pair.

26.3 Price the selected flight(s) with the following variable qualifier values and the previously defined qualifier values: Preferred Airline Class=the user's Personal Preferences value; the Accept Penalties/Restrictions value=user's Personal Preferences value.

26.4 Determine the duration of flights or group of flights returned for the City Pair.

26.5 Determine the flight with the shortest duration (baseline).

26.6 Determine the list of flights which have a variance in duration time of ±10% of the baseline.

26.7 Select the flight(s) with the shortest duration, regardless of airport.

27. Given Duration=Primary and Full Fare Auto Upgrades=Secondary

27.1 Execute an availability request for each City Pair using the following variable qualifier values and the previously defined qualifier values: Preferred Airlines=All;

27.2 Initiate an initial flight selection for the City Pair.

27.3 Price the selected flight(s) with the following variable qualifier values and the previously defined qualifier values: Preferred Airline Class=the user's Personal Preferences value; Accept Penalties/Restrictions value=the user's Personal Preferences value.

27.4 Determine the duration of flights or group of flights returned for the City Pair.

27.5 Determine the flight with the shortest duration (baseline).

27.6 Determine the list of flights which have a variance in duration time of ±10% of the baseline.

27.7 If the user's Personal Preferences Accept Penalties/Restrictions value is ‘Y,’ select and sell the lowest fare within the duration range.

27.8 If the user's Personal Preferences Accept Penalties/Restrictions value is ‘N,’ and there is an Auto Upgrade Fare within the defined duration range, select and sell the lowest price Upgrade fare within the range.

27.9 If the user's Personal Preferences Accept Penalties/Restrictions value is ‘N,’ and there are no Auto Upgrade Fares, select and sell the lowest price fare within the range.

28. Given Full Fare Auto Upgrades=Primary and Duration=Secondary

28.1 Execute an availability request for each City Pair using the following variable qualifier values and the previously defined qualifier values: Preferred Airlines=All;

28.2 Initiate an initial flight selection for the City Pair.

28.3 Price the selected flight(s) with the following variable qualifier values and the previously defined qualifier values: Preferred Airline Class=the user's Personal Preferences value; Accept Penalties/Restrictions value=the user's Personal Preferences value.

28.4 If an Upgrade fare is returned in the pricing, apply duration requirements, as defined above, then select and sell the Upgrade fare with the shortest duration.

28.5 If an Upgrade fare is not returned in the pricing, apply duration requirements, as defined above, then select and sell the fare with the shortest duration.

29. Given Duration=Primary and Preferred Airlines=Secondary

29.1 Execute an availability request for each City Pair using the following variable qualifier values and the previously defined qualifier values: Preferred Airlines=All;

29.2 Initiate an initial flight selection for the City Pair.

29.3 Price the selected flight(s) with the following variable qualifier values and the previously defined qualifier values: Preferred Airline Class=the user's Personal Preferences value; The Accept Penalties/Restrictions value=the user's Personal Preferences value.

29.4 Determine the duration of flights or group of flights returned for the City Pair.

29.5 Determine the flight with the shortest duration (baseline).

29.6 Determine the list of flights which have a variance in duration time of ±10% of the baseline.

29.7 If the duration range subset contains flights for the user's Preferred Airlines, select and sell the flight(s) for the highest prioritized Preferred Airline.

29.8 If the duration range subset does not contain flights for the user's Preferred Airlines, select and sell the flight(s) with the shortest duration time.

30. Given Preferred Airlines=Primary and Duration=Secondary

30.1 Execute an availability request for each City Pair using the following variable qualifier values and the previously defined qualifier values: Preferred Airlines=up to the first three prioritized airlines in User Profile—Personal Preferences; Alternate Airports=user's Profile Personal Preferences value.

30.2 Initiate an initial flight selection for the City Pair.

30.3 Price the selected flight(s) with the following variable qualifier values and the previously defined qualifier values: Preferred Airline Class=the user's Personal Preferences value; The Accept Penalties/Restrictions value=user's Personal Preferences.

30.4 Select and sell the flight(s) for the highest prioritized Preferred Airline, as indicated in the user's Personal Preferences. If more than one flight or set of flights exist for the highest prioritized Preferred Airline, select the flight with the shortest duration.

31. Given Non-Stop=Primary and Alternate Airport=Secondary

31.1 Execute an availability request for each City Pair using the following variable qualifier values and the previously defined qualifier values: Preferred Airlines=All;

31.2 Initiate an initial flight selection for the City Pair.

31.3 Price the selected flight(s) with the following variable qualifier values and the previously defined qualifier values: Preferred Airline Class=the user's Personal Preferences value; The Accept Penalties/Restrictions value=the user's Personal Preferences value.

31.4 Select and sell the lowest priced Non-stop flight in the returned price list.

31.5 If a Non-stop flight is not available, select and sell the lowest priced Direct flight in the returned price list.

31.6 If a Direct flight is not available, select and sell the lowest priced Online Connection flight in the returned price list.

31.7 If an Online Connection flight is not available, select and sell the lowest priced Interline Connection flight in the returned price list.

31.8 If an Interline Connection flight is not available, select and sell the lowest priced Multi-online Connection flight in the returned price list.

31.9 If a Multi-online Connection flight is not available, select and sell the lowest priced Multi-interline Connection flight in the returned price list.

32. Given Alternate Airport=Primary and Non-Stop=Secondary

32.1 Execute an availability request for each City Pair using the following variable qualifier values and the previously defined qualifier values: Preferred Airlines=up to the first three prioritized airlines in User Profile—Personal Preferences; Alternate Airports=‘Y,’ regardless of Personal Preferences value.

32.2 Initiate an initial flight selection for the City Pair.

32.3 Price the selected flight(s) with the following variable qualifier values and the previously defined qualifier values: Preferred Airline Class=the user's Personal Preferences value; The Accept Penalties/Restrictions value=user's Personal Preferences.

32.4 Select and sell the lowest priced Non-stop flight in the returned price list.

32.5 If a Non-stop flight is not available, select and sell the lowest priced Direct flight in the returned price list.

32.6 If a Direct flight is not available, select and sell the lowest priced Online Connection flight in the returned price list.

32.7 If an Online Connection flight is not available, select and sell the lowest priced Interline Connection flight in the returned price list.

32.8 If an Interline Connection flight is not available, select and sell the lowest priced Multi-online Connection flight in the returned price list.

32.9 If a Multi-online Connection flight is not available, select and sell the lowest priced Multi-interline Connection flight in the returned price list.

33. Given Non-Stop=Primary and Full Fare Auto Upgrades=Secondary

33.1 Execute an availability request for each City Pair using the following variable qualifier values and the previously defined qualifier values: Preferred Airlines=All;

33.2 Initiate an initial flight selection for the City Pair.

33.3 Price the selected flight(s) with the following variable qualifier values and the previously defined qualifier values: Preferred Airline Class=the user's Personal Preferences value; The Accept Penalties/Restrictions value=the user's Personal Preferences value.

33.4 If Upgrade Fares are returned for a Non-stop flight, select and sell the Non-stop flight with the Upgrade.

33.5 If no Upgrade Fares are returned for a Non-stop flight, select and sell the Non-stop flight with the lowest price.

33.6 If a Non-stop flight is not available and Upgrade Fares are returned for Direct flight(s), select and sell the lowest priced Direct flight(s).

33.7 If a Non-stop flight is not available and Upgrade Fares are not returned for Direct flight(s), select and sell the lowest priced Direct flight.

33.8 If a Direct flight is not available and Upgrade Fares are returned for Online Connection flight(s), select and sell the lowest priced Online Connection flight(s).

33.9 If a Direct flight is not available and Upgrade Fares are not returned for Online Connection flight(s), select and sell the lowest priced Online Connection flight.

33.10 If an Online Connection flight is not available and Upgrade Fares are returned for Interline Connection flight(s), select and sell the lowest priced Interline Connection flight(s).

33.11 If an Online Connection flight is not available and Upgrade Fares are not returned for Interline Connection flight(s), select and sell the lowest priced Interline Connection flight.

33.12 If an Interline Connection flight is not available and Upgrade Fares are returned for Multi-online flight(s), select and sell the lowest priced Multi-online flight(s).

33.13 If an Interline Connection flight is not available and Upgrade Fares are not returned for Multi-online flight(s), select and sell the lowest priced Multi-online flight.

33.14 If a Multi-online flight is not available and Upgrade Fares are returned for Multi-interline flight(s), select and sell the lowest priced Multi-interline flight(s).

33.15 If a Multi-online flight is not available and Upgrade Fares are not returned for Multi-interline flight(s), select and sell the lowest priced Multi-interline flight.

34. Given Full Fare Auto Upgrades=Primary and Non-Stop=Secondary

34.1 Execute an availability request for each City Pair using the following variable qualifier values and the previously defined qualifier values: Preferred Airlines=up to the first three prioritized airlines in User Profile—Personal Preferences; Alternate Airports=‘Y,’ regardless of Personal Preferences value.

34.2 Initiate an initial flight selection for the City Pair.

34.3 Price the selected flight(s) with the following variable qualifier values and the previously defined qualifier values: Preferred Airline Class=the user's Personal Preferences value; The Accept Penalties/Restrictions value=user's Personal Preferences.

34.4 If an Upgrade fare is returned in the pricing, select and sell the lowest priced Upgrade fare, progressing through Non-stop, Direct, Online Connection, Interline Connection, Multi-online, and Multi-interline flights(s), in that order, until an Upgrade Fare is selected and sold.

34.5 If an Upgrade fare is not returned in pricing and If the Accept Penalties/Restrictions value is ‘N’ in the user's Personal Preferences, cycle through Flight types, in order. Select and sell the lowest fare within the first ordered flight type found.

34.6 If an Upgrade fare is not returned in pricing and If the Accept Penalties/Restrictions value is ‘Y’ in the user's Personal Preferences, re-price the original itinerary with penalties and restrictions, cycle through Flight types, in order. Select and sell the lowest fare within the first ordered flight type found.

35. Given Non-Stop=Primary and Preferred Airlines=Secondary

35.1 Execute an availability request for each City Pair using the following variable qualifier values and the previously defined qualifier values: Preferred Airlines=All;

35.2 Initiate an initial flight selection for the City Pair.

35.3 Price the selected flight(s) with the following variable qualifier values and the previously defined qualifier values: Preferred Airline Class=the user's Personal Preferences value; The Accept Penalties/Restrictions value=user's Personal Preferences.

35.4 Look for Non-stop, Direct, Online Connection, Interline Connection, Multi-online, and Multi-interline flights(s), in that order, until a flight type is found.

35.5 If a prioritized Preferred Airline is found in the group of flights for the first flight type found, select and sell the flight(s) for the prioritized airline.

35.6 If a prioritized Preferred Airline is not found in the group of flights for the first flight type found, select and sell the lowest priced flight(s) in the flight type.

36. Given Preferred Airlines=Primary and Non-Stop=Secondary

36.1 Execute an availability request for each City Pair using the following variable qualifier values and the previously defined qualifier values: Preferred Airlines=up to the first three prioritized airlines in User Profile—Personal Preferences;

36.2 Initiate an initial flight selection for the City Pair.

36.3 Price the selected flight(s) with the following variable qualifier values and the previously defined qualifier values: Preferred Airline Class=the user's Personal Preferences value; The Accept Penalties/Restrictions value=user's Personal Preferences.

36.4 Look for Non-stop, Direct, Online Connection, Interline Connection, Multi-online, and Multi-interline flights(s), in that order, until a flight type is found.

36.5 Select and sell the lowest fare available, by Preferred Airline priority, for the first group of flight types found.

37. Given Alternate Airport=Primary and Full Fare Auto Upgrades=Secondary

37.1 Execute an availability request for each City Pair using the following variable qualifier values and the previously defined qualifier values: Preferred Airlines=All; Alternate Airports=Y, regardless of Personal Preferences setting.

37.2 Initiate an initial flight selection for the City Pair.

37.3 Price the selected flight(s) with the following variable qualifier values and the previously defined qualifier values: Preferred Airline Class=the user's Personal Preferences value; Accept Penalties/Restrictions value=the user's Personal Preferences value.

37.4 If Upgrade Fares are available, select and sell the lowest priced upgrade fare.

37.5 If no Upgrades are available, select and sale the lowest price fare.

38. Given Full Fare Auto Upgrades=Primary and Alternate Airport=Secondary

38.1 Execute an availability request for each City Pair using the following variable qualifier values and the previously defined qualifier values: Preferred Airlines=All; Alternate Airports=Personal Preferences value.

38.2 Initiate an initial flight selection for the City Pair.

38.3 Price the selected flight(s) with the following variable qualifier values and the previously defined qualifier values: Preferred Airline Class=the user's Personal Preferences value; Accept Penalties/Restrictions value=‘N.’

38.4 If an Upgrade Fare is returned, select and sell the lowest price Upgrade Fare.

38.5 If no Upgrade is returned and the user's Penalties/Restrictions value=‘N,’ select and sell the lowest priced fare.

38.6 If no Upgrade is returned and the user's Penalties/Restrictions value=‘Y,’ re-price the original selection, then select and sell the lowest priced fare.

39. Given Alternate Airport=Primary and Airlines=Secondary

39.1 Execute an availability request for each City Pair using the following variable qualifier values and the previously defined qualifier values: Preferred Airlines=All; Alternate Airports=Y, regardless of Personal Preferences setting.

39.2 Initiate an initial flight selection for the City Pair.

39.3 Price the selected flight(s) with the following variable qualifier values and the previously defined qualifier values: Preferred Airline Class=the user's Personal Preferences value; Accept Penalties/Restrictions value=the user's Personal Preferences value.

39.4 Select and sale the lowest price fare.

40. Given Airlines=Primary and Alternate Airport=Secondary

40.1 Execute an availability request for each City Pair using the following variable qualifier values and the previously defined qualifier values: Preferred Airlines=up to the top three prioritized airlines in the user's Preferred Airlines list; Alternate Airports=Personal Preferences value.

40.2 Initiate an initial flight selection for the City Pair.

40.3 Price the selected flight(s) with the following variable qualifier values and the previously defined qualifier values: Preferred Airline Class=the user's Personal Preferences value; Accept Penalties/Restrictions value=user's Personal Preferences value.

40.4 If an Upgrade Fare is returned, select and sell the lowest price Upgrade Fare.

40.5 If no Upgrade is returned and the user's Penalties/Restrictions value=‘N,’ select and sell the lowest priced fare.

40.6 If no Upgrade is returned and the user's Penalties/Restrictions value=‘Y,’ re-price the original selection with an Accept Penalties/Restrictions value=‘Y, then select and sell the lowest priced fare.

41. Given Full Fare Auto Upgrades=Primary and Airlines=Secondary

41.1 Execute an availability request for each City Pair using the following variable qualifier values and the previously defined qualifier values: Preferred Airlines=All; Alternate Airports=user's Personal Preferences value.

41.2 Initiate an initial flight selection for the City Pair.

41.3 Price the selected flight(s) with the following variable qualifier values and the previously defined qualifier values: Preferred Airline Class=the user's Personal Preferences value; Accept Penalties/Restrictions value=‘N,’ regardless of Personal Preferences value.

41.4 If Upgrade Fares are returned, select and sell the lowest priced Upgrade Fare for the prioritized Preferred Airline.

41.5 If no Upgrade Fares are returned and the user's Accept Penalties/Restrictions value=‘N,’ select and sell the lowest price fare.

41.6 If no Upgrade Fares are returned and the user's Accept Penalties/Restrictions value=‘Y,’ re-price the original selection with Accept Penalties/Restrictions value=‘Y,’ then select and sell the lowest priced fare.

42. Given Airlines=Primary and Full Fare Auto Upgrades=Secondary

42.1 Execute an availability request for each City Pair using the following variable qualifier values and the previously defined qualifier values: Preferred Airlines=up to the top three prioritized airlines in the user's Preferred Airlines list; Alternate Airports=Personal Preferences value.

42.2 Initiate an initial flight selection for the City Pair.

42.3 Price the selected flight(s) with the following variable qualifier values and the previously defined qualifier values: Preferred Airline Class=the user's Personal Preferences value; Accept Penalties/Restrictions value=user's Personal Preferences value.

42.4 If an Upgrade Fare is returned, select and sell the lowest price Upgrade Fare for the airline, first prioritized.

42.5 If no Upgrade is returned, select and sell the lowest priced fare for the first prioritized airline.

What is claimed is:

1. A system for automatically planning, booking and calendaring travel arrangements, the system comprising:
a data storage device;
a booking engine;
an output device;
a processor programmed to:
maintain in the storage device a database of user profile information including information regarding air travel booking preferences, car booking preferences, hotel booking preferences and personal preference air travel ratings,
receive a travel request input including travel request data gathered from a user's calendar application,
use the stored user profile information and the travel request data to automatically formulate a travel request in response to the travel request input, the travel request including airline, hotel and rental car reservation information,
automatically create a travel query file by applying business rules to the travel request, including:
automatically executing an air booking process based on at least two categories of user preference information selected from the group of categories of lowest price,
arrival/departure time, airline, non-stop, duration, alternate airports and full fare automobile upgrades,
automatically executing a car booking process for selecting, and
automatically executing a hotel booking process,
submit the query file to a booking engine for creating a travel request query,
submit the travel request query to a travel distribution system for retrieving air, car and hotel availability information,
receive from the travel distribution system the air, car and hotel availability information and create a suggested travel itinerary,
output for display on a user display device the suggested travel itinerary,
allow manual changes to be made to the suggested travel itinerary,
accept manual confirmation of the suggested travel itinerary; and
process data from the confirmed travel itinerary for automatically creating and storing appointment events in a user's calendar application.

2. A method for automatically planning, booking and calendaring travel arrangements, the method comprising:
maintaining in a computer storage device a database of user profile information including information regarding air travel booking preferences, car booking preferences, hotel booking preferences and personal preference air travel ratings;
receiving a travel request input including travel request data gathered from a user's calendar application;
using the stored user profile information and the travel request data to automatically formulate a travel request in response to the travel request input, the travel request including airline, hotel and rental car reservation information;
automatically creating a travel query file by applying business rules to the travel request, including:
automatically executing an air booking process based on at least two categories of user preference information selected from the group of categories of lowest price, arrival/departure time, airline, non-stop, duration, alternate airports and full fare automobile upgrades,
automatically executing a car booking process for selecting, and automatically executing a hotel booking process,
submitting the query file to a booking engine for creating a travel request query;
submitting the travel request query to a travel distribution system for retrieving air, car and hotel availability information;
receiving from the travel distribution system the air, car and hotel availability information and creating a suggested travel itinerary;
outputting for display on a user display device the suggested travel itinerary;
allowing manual changes to be made to the suggested travel itinerary;
accepting manual confirmation of the suggested travel itinerary;
automatically creating and storing appointment events in the calendar application using data from the confirmed travel itinerary.
